(19) United States
(12) Patent Application Publication
(10) Pub. No.: US 2009/0211604 A1
(43) Pub. Date: Aug. 27, 2009

(54) System and Method For Removing Edge-Bead Material

(75) Inventors: Thomas Winter, Pleasant Valley, NY (US); James Klekotka, Fountain Hills, AZ (US)

Correspondence Address: Tokyo Electron U.S. Holdings, Inc., 4350 West Chandler Blvd., Suite 10/11, Chandler, AZ, 85226, US

(73) Assignee: TOKYO ELECTRON LIMITED, Tokyo (JP)

(21) Appl. No.: 12/035,520

(22) Filed: Feb. 22, 2008

(51) Int. Cl. B08B 7/04; B08B 13/00

(52) U.S. Cl. 134/18; 134/56 R

(57) ABSTRACT

Embodiments of the invention provide edge-bead removal systems and methods for removing edge-bead material from one or more surfaces of semiconductor wafers. Embodiments of the invention may be applied to process wafers at different points in a manufacturing cycle, and the wafers can include one or more metal layers.

### CROSS-REFERENCE TO RELATED APPLICATIONS

This application is related to co-pending Attorney docket number FKL-067, entitled “System and Method For Removing Edge-Bead Material”, filed herewith; and FKL-072, entitled “System and Method For Removing Post-Etch Residue”, filed herewith. The contents of each of these applications are herein incorporated by reference in their entireties.

### FIELD OF THE INVENTION

The invention relates to wafer processing, and more particularly, to a Edge-bead Removal System and method for using the same.

### BACKGROUND OF THE INVENTION

Minimizing defects during wafer processing will continue to be a critical path to attaining cost effective manufacturing of advanced semiconductor devices. Hard particles can block etch processes causing an electrical “open” or “short” in the circuit. In of lesser size and if lucky with the location on the device, the hard particle may only create fatal perturbations in the active features' critical dimension (line/space or contact hole)

The required gate level defect density for 15 nm gate technology is going to be approximately 0.01/cm² at 10 nm in size per International Technology Roadmap for Semiconductors (ITRS) 2005 roadmap. Prior art edge-bead cleaning procedures are not adequate to meet these requirements and it is anticipated that an improved edge-bead removing system and associated procedures will be required to meet the future device defect densities.

### SUMMARY OF THE INVENTION

Embodiments of the invention provide edge-bead removal systems, subsystem, and procedures for removing edge-bead material from one or more surfaces of semiconductor wafers. Embodiments of the invention may be applied to process wafers at different points in a manufacturing cycle, and the wafers can include one or more metal layers.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 is a top view of a schematic diagram of a coating/developing processing system for use in accordance with embodiments of the invention;

FIG. 2 is a front view of the coating/developing processing system of FIG. 1;

FIG. 3 is a partially cut-away back view of the coating/developing processing system of FIG. 1, as taken along line 3-3;

FIGS. 4a-4c show exemplary schematic views of a edge-bead removal system in accordance with embodiments of the invention;

FIGS. 5a-5c show exemplary schematic views of another edge-bead removal system in accordance with embodiments of the invention;

FIGS. 6a-6c show exemplary schematic views of an additional edge-bead removal system in accordance with embodiments of the invention;

FIG. 7 show exemplary schematic views of an additional edge-bead removal system in accordance with embodiments of the invention; and

FIG. 8 illustrates a simplified process flow diagram for a method for using a edge-bead removal system according to embodiments of the invention.

### DETAILED DESCRIPTION

Embodiments of the invention provide edge-bead removal systems, subsystems, and procedures for removing edge-bead material from one or more surfaces of semiconductor wafers using edge-bead removal systems. Embodiments of the invention may be applied to process wafers at different points in a manufacturing cycle, and the wafers can include one or more metal layers. The terms “wafer” and “substrate” are used interchangeably herein to refer to a thin slice of material, such as a silicon crystal or glass material, upon which microcircuits are constructed, for example by diffusion, deposition, and etching of various materials.

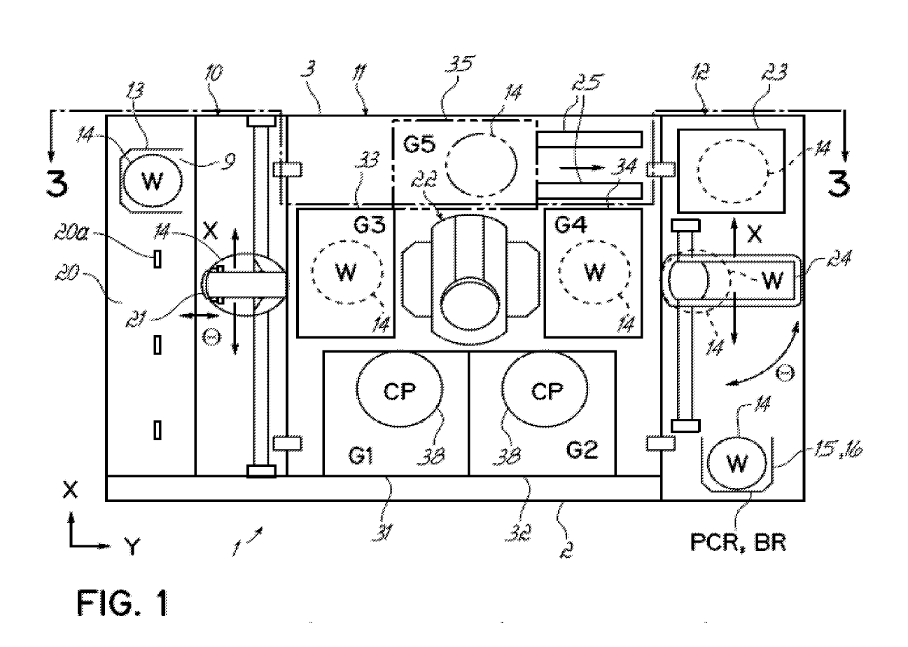

With reference to FIGS. 1-3, a coating/developing processing system 1 has a load/unload section 10, a process section 11, and an interface section 12. The load/unload section 10 has a cassette table 20 on which cassettes (CR) 13, each storing a plurality of semiconductor wafers (W) 14 (e.g., 25), are loaded and unloaded from the processing system 1. The process section 11 has various single wafer processing units for processing wafers 14 sequentially one by one. These processing units are arranged in predetermined positions of multiple stages, for example, within first (G1), second (G2), third (G3), fourth (G4) and fifth (G5) multiple-stage process unit groups 31, 32, 33, 34, 35. The interface section 12 is interposed between the process section 11 and one or more light exposure systems (not shown), and is configured to transfer resist coated wafers between the process section. The one or more light exposure systems can include a resist patterning system such as a photolithography tool that transfers the image of a circuit or a component from a mask onto a resist on the wafer surface.

The coating/developing processing system 1 also includes a CD metrology system for obtaining CD metrology data from test areas on the patterned wafers. The CD metrology system may be located within the processing system 1, for example at one of the multiple-stage process unit groups 31, 32, 33, 34, 35. The CD metrology system can be a light scattering system such as an optical digital Profilometry (ODP) system.

The ODP system may include a scatterometer, incorporating beam profile ellipsometry (ellipsometer), and beam profile reflectometry (reflectometer), commercially available from Therma-Wave, Inc. (1250 Reliance Way, Fremont, Calif. 94539) or Nanometrics, Inc. (1550 Buckeye Drive, Milpitas, Calif. 95035). ODP software is available from Timbre Technologies Inc. (2953 Bunker Hill Lane, Santa Clara, Calif. 95054).

When performing optical metrology, such as Scatterometry, a structure on a substrate, such as a semiconductor wafer or flat panel, is illuminated with electromagnetic (EM) radiation, and a diffracted signal received from the structure is utilized to reconstruct the profile of the structure. The structure may include a periodic structure, or a non-periodic structure. Additionally, the structure may include an operating structure on the substrate (i.e., a via, or contact hole, or an interconnect line or trench, or a feature formed in a mask layer associated therewith), or the structure may include a periodic grating or non-periodic grating formed proximate to an operating structure formed on a substrate. For example, the periodic grating can be formed adjacent a transistor formed on the substrate. Alternatively, the periodic grating can be formed in an area of the transistor that does not interfere with the operation of the transistor. The profile of the periodic grating is obtained to determine whether the periodic grating, and by extension the operating structure adjacent the periodic grating, has been fabricated according to specifications.

Still referring to FIGS. 1-3, a plurality of projections 20a are formed on the cassette table 20. A plurality of cassettes 13 are each oriented relative to the process section 11 by these projections 20a. Each of the cassettes 13 mounted on the cassette table 20 has a load/unload opening 9 facing the process section 11.

The load/unload section 10 includes a first sub-arm mechanism 21 that is responsible for loading/unloading the wafer W into/from each cassette 13. The first sub-arm mechanism 21 has a holder portion for holding the wafer 14, a back and forth moving mechanism (not shown) for moving the holder portion back and forth, an X-axis moving mechanism (not shown) for moving the holder portion in an X-axis direction, a Z-axis moving mechanism (not shown) for moving the holder portion in a Z-axis direction, and a 0 (theta) rotation mechanism (not shown) for rotating the holder portion around the Z-axis. The first sub-arm mechanism 21 can gain access to an alignment unit (ALIM) 41 and an extension unit (EXT) 42 belonging to a third (G3) process unit group 33, as further described below.

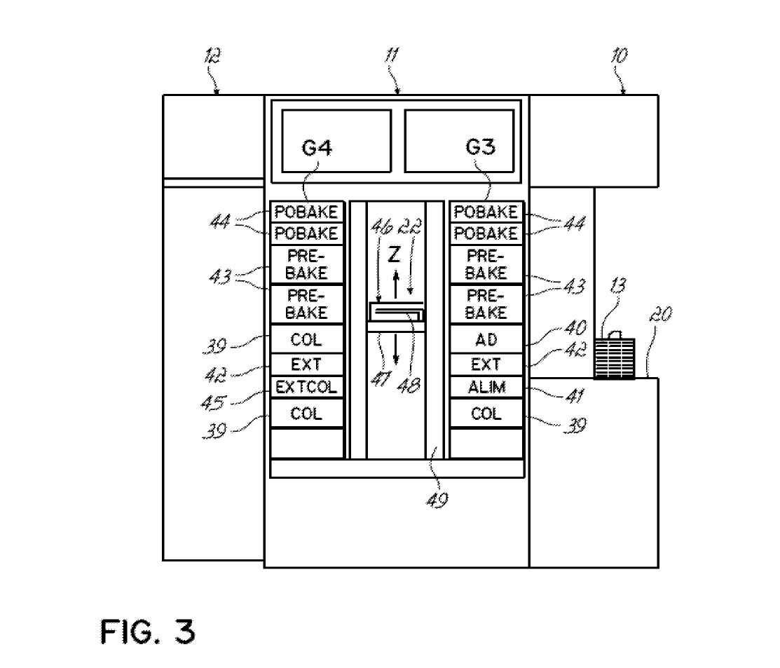

With specific reference to FIG. 3, a main arm mechanism 22 is liftably arranged at the center of the process section 11. The process units G1-G5 are arranged around the main arm mechanism 22. The main arm mechanism 22 is arranged within a cylindrical supporting body 49 and has a liftable wafer transporting system 46. The cylindrical supporting body 49 is connected to a driving shaft of a motor (not shown). The driving shaft may be rotated about the Z-axis in synchronism with the wafer transporting system 46 by an angle of θ. The wafer transporting system 46 has a plurality of holder portions 48 movable in a front and rear direction of a transfer base table 47.

Units belonging to first (G1) and second (G2) process unit groups 31, 32, are arranged at the front portion 2 of the coating/developing processing system 1. Units belonging to the third (G3) process unit group 33 are arranged next to the load/unload section 10. Units belonging to a fourth (G4) process unit group 34 are arranged next to the interface section 12. Units belonging to a fifth (G5) process unit group 35 are arranged in a back portion 3 of the processing system 1.

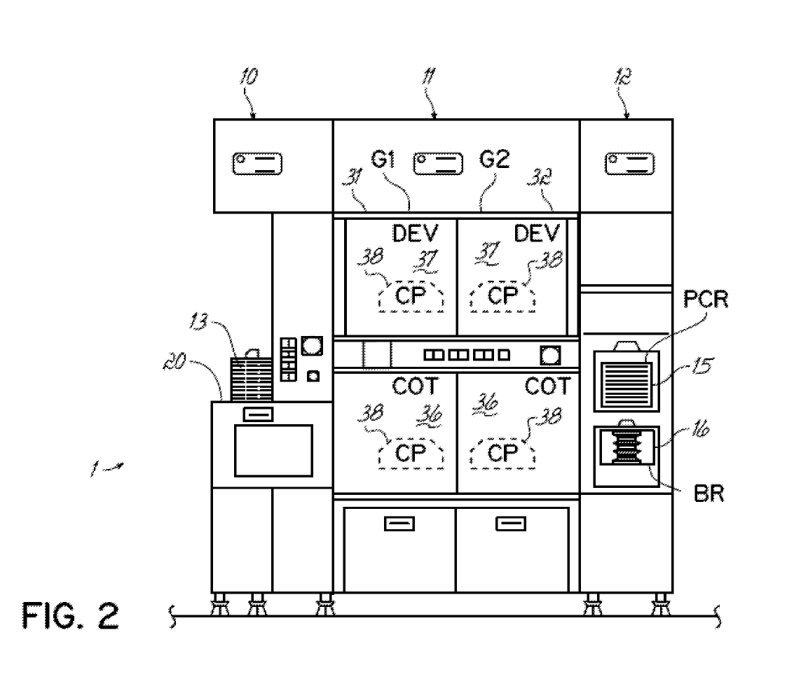

With reference to FIGS. 1 and 2, the first (G1) process unit group 31 has two spinner-type process units for applying a predetermined treatment to the wafer 14 mounted on a spin chuck (not shown) within the cup (CP) 38. In the first (G1) process unit group 31, for example, a resist coating unit (COT) 36 and a developing unit (DEV) 37 are stacked in two stages sequentially from the bottom. In the second (G2) process unit group 32, two spinner type process units such as a resist coating unit (COT) 36 and a developing unit (DEV) 37, are stacked in two stages sequentially from the bottom. In an exemplary embodiment, the resist coating unit (COT) 36 is set at a lower stage than the developing unit (DEV) 37 because a discharge line (not shown) for the resist waste solution is desired to be shorter than a developing waste solution for the reason that the resist waste solution is more difficult to discharge than the developing waste solution. However, if necessary, the resist coating unit (COT) 36 may be arranged at an upper stage relative to the developing unit (DEV) 37.

With reference to FIGS. 1 and 3, the third (G3) process unit group 33 has a cooling unit (COL) 39, an alignment unit (ALIM) 41, an adhesion unit (AD) 40, an extension unit (EXT) 42, two prebaking units (PREBAKE) 43, and two postbaking units (POBAKE) 44, which are stacked sequentially from the bottom.

Similarly, the fourth (G4) process unit group 34 has a cooling unit (COL) 39, an extension-cooling unit (EXTCOL) 45, an extension unit (EXT) 42, another cooling unit (COL) 39, two prebaking units (PREBAKE) 43 and two postbaking units (POBAKE) 44 stacked sequentially from the bottom. Although, only two prebaking units 43 and only two postbaking units 44 are shown, G3 and G4 may contain any number of prebaking units 43 and postbaking units 44. Furthermore, any or all of the prebaking units 43 and postbaking units 44 may be configured to perform PEB, post application bake (PAB), and post developing bake (PDB) processes.

In an exemplary embodiment, the cooling unit (COL) 39 and the extension cooling unit (EXTCOL) 45, to be operated at low processing temperatures, are arranged at lower stages, and the prebaking unit (PREBAKE) 43, the postbaking unit (POBAKE) 44 and the adhesion unit (AD) 40, to be operated at high temperatures, are arranged at the upper stages. With this arrangement, thermal interference between units may be reduced. Alternatively, these units may have different arrangements.

At the front side of the interface section 12, a movable pick-up cassette (PCR) 15 and a non-movable buffer cassette (BR) 16 are arranged in two stages. At the backside of the interface section 12, a peripheral light exposure system 23 is arranged. The peripheral light exposure system 23 can contain a lithography tool or and ODP system. Alternately, the lithography tool and the ODP system may be remote to and cooperatively coupled to the coating/developing processing system 1. At the center portion of the interface section 12, a second sub-arm mechanism 24 is provided, which is movable independently in the X and Z directions, and which is capable of gaining access to both cassettes (PCR) 15 and (BR) 16 and the peripheral light exposure system 23. In addition, the second sub-arm mechanism 24 is rotatable around the Z-axis by an angle of θ and is designed to be able to gain access not only to the extension unit (EXT) 42 located in the fourth (G4) processing unit group 34 but also to a wafer transfer table (not shown) near a remote light exposure system (not shown).

In the processing system 1, the fifth (G5) processing unit group 35 may be arranged at the back portion 3 of the backside of the main arm mechanism 22. The fifth (G5) processing unit group 35 may be slidably shifted in the Y-axis direction along a guide rail 25. Since the fifth (G5) processing unit group 35 may be shifted as mentioned, maintenance operation may be applied to the main arm mechanism 22 easily from the backside.

The prebaking unit (PREBAKE) 43, the postbaking unit (POBAKE) 44, and the adhesion unit (AD) 40 each comprise a heat treatment system in which wafers 14 are heated to temperatures above room temperature.

In some embodiments, the coating/developing processing system 1 can include one or more edge-bead removal systems that may be incorporated into the coating/developing processing system 1, or be incorporated as additional modules.

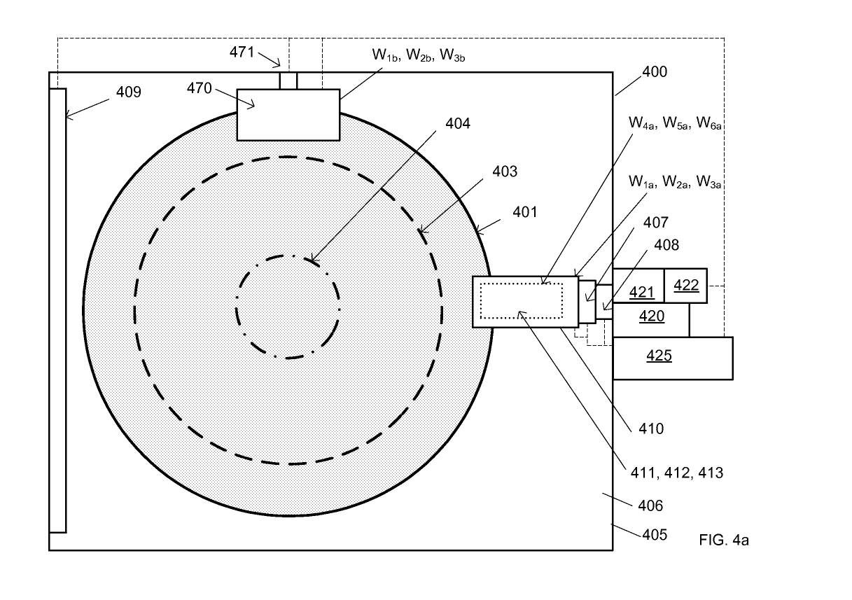

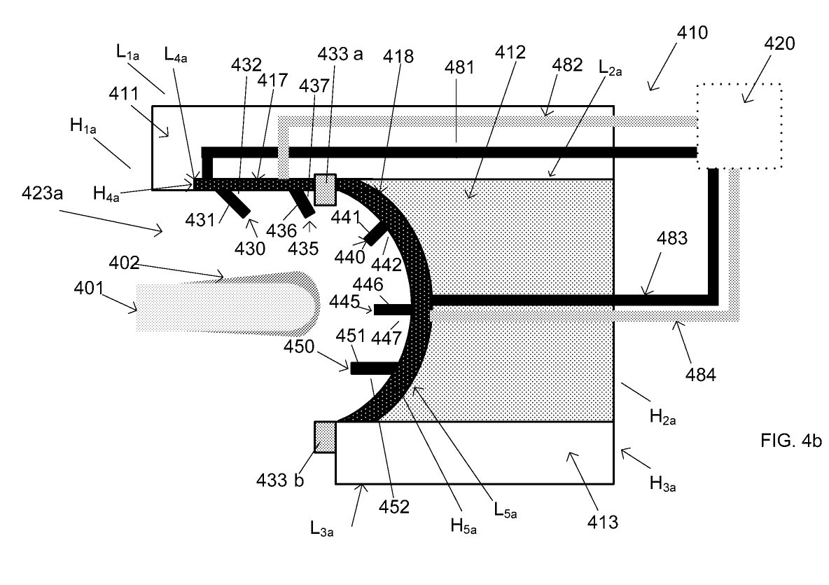

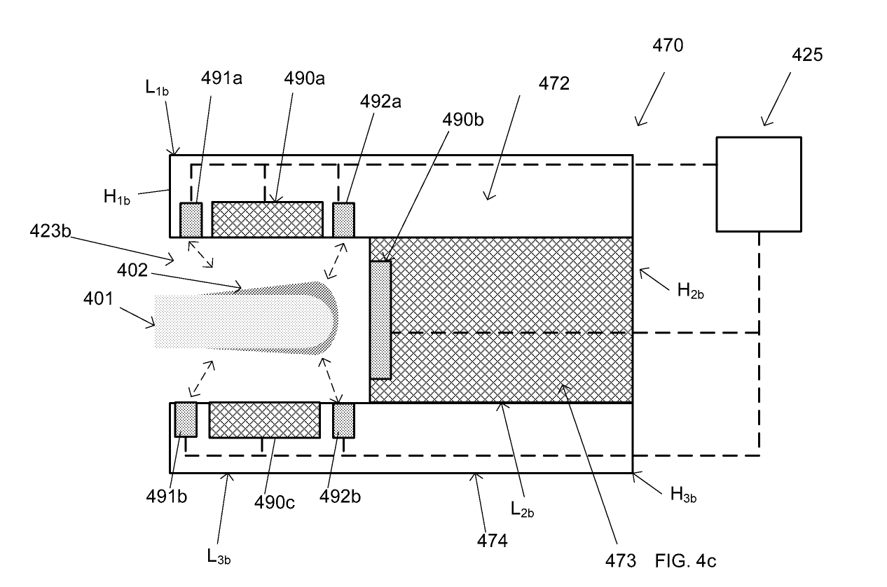

FIGS. 4a-4c show exemplary schematic views of a edge-bead removal system in accordance with embodiments of the invention. In the illustrated embodiment, an exemplary edge-bead removal system 400 is shown that comprises a processing chamber 405, a wafer table 403 for supporting a wafer 401, and a translation unit 404 coupled to the wafer table 403 and to the processing chamber 405. The wafer table 403 can include a vacuum system (not shown) for coupling the wafer 401 to the wafer table 403. The translation unit 404 can be used to align the wafer table 403 in one or more directions and can be used to rotate the wafer table. For example, revolution rates can vary from approximately 0.10 rpm to approximately 6,000 rpm; the revolution rate accuracy can vary from approximately +1 rpm to approximately −1 rpm; and the acceleration rates can vary from approximately 100 rpm/sec to approximately 50,000 rpm/sec.

The edge-bead removal subsystem 410 can be coupled to the processing chamber 405 using first coupling element 407 and second coupling element 408. For example, the first coupling element 407 and second coupling element 408 can be configured as a flexible arm. Edge-bead removal subsystem 410 can comprise an upper cleaning assembly 411, a middle cleaning assembly 412, and a lower assembly 413 that can be used to form a cleaning space 423a. The edge-bead removal system 400 can also include a supply subsystem 420 coupled to the edge-bead removal subsystem 410 and to the processing chamber 405. The supply subsystem 420 can be configured to provide processing fluids and gasses at the correct temperatures and flow rates. For example, processing gasses can include inert gasses, air, reactive gasses, and non-reactive gasses.

The upper cleaning assembly 411 can have a length L₁ₐ, a height H₁ₐ, and a width W₁ₐ associated therewith. The length L₁ₐ can vary from approximately 5 mm to approximately 100 mm, the height H₁ₐ can vary from approximately 5 mm to approximately 20 mm, and the width W₁ₐ can vary from approximately 5 mm to approximately 50 mm. The middle cleaning assembly 412 can have a length L₂ₐ, a height H₂ₐ, and a width W₂ₐ associated therewith. The length L₂ₐ can vary from approximately 5 mm to approximately 50 mm, the height H₂ₐ can vary from approximately 5 mm to approximately 20 mm, and the width W₂ₐ can vary from approximately 5 mm to approximately 50 mm. The lower assembly 413 can have a length L₃ₐ a height H₃ₐ, and a width W₃ₐ associated therewith. The length L₃ₐ can vary from approximately 5 mm to approximately 50 mm, the height H₃ₐ can vary from approximately 5 mm to approximately 20 mm, and the width W₃ₐ can vary from approximately 5 mm to approximately 50 mm.

The edge-bead removal system 400 can include a temperature control subsystem 470, and the temperature control subsystem 470 can be coupled to the processing chamber 405 at a first location using one or more coupling elements 471. For example, the one or more coupling elements 471 can be configured as flexible arms. A more detailed view of an exemplary temperature control subsystem 470 is shown in FIG. 4c.

The processing chamber 405 can include one or more exhaust ports 421 coupled to the process space 406. For example, the exhaust port 421 may comprise one or more valves (not shown) and/or one or more exhaust sensors (not shown). Those skilled in the art will recognize that the one or more valves may be used for controlling flow in and/or out of the process space 406, and one or more exhaust sensors may be used for determining the processing state for the edge-bead removal system 400. In addition, one or more of the exhaust ports 421 may be coupled to an evacuation unit (not shown) and/or an exhaust system (not shown) using flexible hoses/tubes/pipes/conduits. Exhaust port 421 can be used to exhaust cleaning and/or other processing gasses that must be removed from the process space 406.

Processing chamber 405 can include a wafer transfer port 409 that can be opened during wafer transfer procedures and closed during wafer processing.

The edge-bead removal system 400 can comprise one or more recovery systems 422, and the recovery system 422 can be configured to analyze, filter, re-use and/or remove one or more processing fluids. For example, some solvents may be re-used.

In addition, the edge-bead removal system 400 can include a controller 425 that can be coupled to the wafer table 403, the translation unit 404, the processing chamber 405, the edge-bead removal subsystem 410, the first coupling element 407, the second coupling element 408, the supply subsystem 420, exhaust port 421, recovery system 422 a temperature control subsystem 470, coupling elements 471, and the wafer transfer port 409. Alternatively, other configurations may be used.

Referring to FIG. 4b, a simplified exploded view is shown for an exemplary edge-bead removal subsystem 410. In the exemplary exploded view, a portion of a wafer 401 is shown along with an exemplary portion of a edge-bead material 402. Alternatively, the shape, size, and position of the edge-bead material can be different.

In the illustrated embodiment, a first flow controller 417 is shown in an exploded view of the upper cleaning assembly 411, and a second flow controller 418 is shown in an exploded view of the middle cleaning assembly 412. In addition, an upper sensor unit 433a is shown coupled to the upper cleaning assembly 411, and a lower sensor unit 433b is shown coupled to the lower assembly 413. The upper sensor unit 433a and the lower sensor unit 433b can be used to determine processing states, positions, thicknesses, temperatures, pressures, flow rates, chemistries, spin rates, acceleration rates, residues, or particles, or any combination thereof.

The upper cleaning assembly 411 can include one or more first flow controllers 417 that can be coupled to a first supply line 481, and a second supply line 482. In various embodiments, one or more of the supply lines (481 and 482) can be operated in a supply mode or in an exhaust mode. In addition, the first flow controller 417 can be coupled to a first flow port 430, and a second flow port 435, and one or more of the flow ports (430 and 435) can be operated as input ports or output ports at various times during processing. In alternate embodiments, different numbers of flow controllers, different numbers of supply lines, and different numbers of flow ports can be used. The first flow controller 417 can monitor and control the first supply line 481, the second supply line 482, the first flow port 430, and the second flow port 435 as required. The first flow port 430 can have a first shape 431 and a first angle 432 associated therewith, and the second flow port 435 can have a second shape 436 and a second angle 437 associated therewith. Alternatively, other shapes and angles may be used.

One or more of the shapes (431 and 436) can be rectangular, cylindrical, and/or tapered, and the angles (432 and 437) can range from approximately 10 degrees to approximately 170 degrees.

The middle cleaning assembly 412 can include one or more second flow controllers 418 that can be coupled to a third supply line 483, and a fourth supply line 484. In various embodiments, one or more of the supply lines (483 and 484) can be operated in a supply mode or an exhaust mode. In addition, the second flow controller 418 can be coupled to a third flow port 440, a fourth flow port 445, and a fifth flow port 450, and one or more of the flow ports (440, 445, and 450) can be operated as input ports or output ports at various times during processing. In alternate embodiments, different numbers of flow controllers, different numbers of supply lines, and different numbers of flow ports can be used.

The second flow controller 418 can monitor and control the third supply line 483, the fourth supply line 484, the third flow port 440, the fourth flow port 445, and the fifth flow port 450 as required. The third flow port 440 can have a third shape 441 and a third angle 442 associated therewith, the fourth flow port 445 can have a fourth shape 446 and a fourth angle 447 associated therewith, and the fifth flow port 450 can have a fifth shape 451 and a fifth angle 452 associated therewith. Alternatively, other configurations may be used.

One or more of the shapes (441, 446, and 451) can be rectangular, cylindrical, and/or tapered, and the angles (442, 447, and 452) can range from approximately 10 degrees to approximately 170 degrees.

The first flow controller 417 can have a length L₄ₐ, a height H₄ₐ, and a width W₄ₐ associated therewith. The length L₄ₐ can vary from approximately 10 mm to approximately 50 mm, the height H₄ₐ can vary from approximately 4 mm to approximately 10 mm, and the width W₄ₐ can vary from approximately 10 mm to approximately 50 mm. The second flow controller 418 can have a length L₅ₐ, a height H₅ₐ, and a width W₅ₐ associated therewith. The length L₅ₐ can vary from approximately 10 mm to approximately 50 mm, the height H₅ₐ can vary from approximately 4 mm to approximately 10 mm, and the width W₅ₐ can vary from approximately 10 mm to approximately 50 mm.

One or more of the flow ports (430, 435, 440, 445, and 450) can have outside diameters that can range from approximately 0.5 mm to approximately 5.0 mm, inside diameters that can range from approximately 0.1 mm to approximately 2.0 mm, and lengths that range from approximately 2 mm to approximately 10 mm. The dimensions can be dependent upon the wafer type, the type of residue being removed, and the chemistries being used. In addition, the distance between the tip of a flow port and the wafer 401 can be changed during processing as the edge-bead removal subsystem 410 is moved with respect to the edge of the wafer. The minimum separation distance can be dependent upon the wafer type, the type of residue being removed, and/or the chemistries being used and can vary from approximately 0.5 mm to approximately 1.5 mm. In other examples, one or more of the flow ports (430, 435, 440, 445, and 450) can include a nozzle, and a nozzle can have a diameter that ranges from approximately 0.1 mm to approximately 2.0 mm, can have a length that ranges from approximately 2 mm to approximately 10 mm.

In some cleaning procedures, Propylene Glycol Monomethyl Ether Acetate can be used as cleaning fluids or rinsing agent. In other removal procedures, other solvents or blends of solvents or liquids can be used based on the type and amount of undesired film. In addition, cleaning fluids or rinsing agents can include the following as single materials or blends: N-Butyl Acetate, Cyclohexanone, Ethyl Lactate, Acetone, Isopropyl alcohol, 4-methyl 2-Pentanone, Gamma Butyl Lactone. In other cleaning procedures, water or diluted HF or diluted sulfuric acid/hydrogen peroxide can be used for removing polymer films and/or edge-bead material.

Referring to FIG. 4c, a simplified exploded view is shown of an exemplary temperature control subsystem 470. In the exemplary exploded view, a thermal control space 423b in shown, and a portion of a wafer 401 is shown along with an exemplary portion of edge-bead material 402 in the thermal control space 423b. Alternatively, the shape, size, and position of the edge-bead material can be different.

In the illustrated embodiment, an exploded view of a first temperature control unit 490a is shown in the upper subassembly 472, an exploded view of a second temperature control unit 490b is shown in the middle subassembly 473, and an exploded view of a third temperature control unit 490c is shown in the lower subassembly 474. The upper subassembly 472 can include a first sensor 491a and a second sensor 492a, and sensors (491a and 492a) can measure positions, thicknesses, temperatures, pressures, flow rates, chemistries, spin rates, acceleration rates, residues, and particles. The first temperature control unit 490a, the first sensor 491a, and the second sensor 492a can be coupled to the controller 425. The controller 425 can monitor and control the first temperature control unit 490a, the first sensor 491a, and the second sensor 492a. Alternatively, other configurations may be used.

The middle subassembly 473 can include the second temperature control unit 490b, and the second temperature control unit 490b can be coupled to the controller 425, so controller 425 can monitor and control the second temperature control unit 490b. Alternatively, the middle subassembly 473 may include sensors (not shown).

The lower subassembly 474 can include a third sensor 491b and a fourth sensor 492b, and sensors (491b and 492b) can determine processing states, positions, thicknesses, temperatures, pressures, flow rates, chemistries, spin rates, acceleration rates, residues, and particles. The third temperature control unit 490c, the third sensor 491b, and the fourth sensor 492b can be coupled to the controller 425. The controller 425 can monitor and control the third temperature control unit 490c, the third sensor 491b, and the fourth sensor 492b. Alternatively, other configurations may be used.

The upper subassembly 472 can have a length L_{1b}, a height H_{1b}, and a width W_{1b} associated therewith. The length L_{1b} can vary from approximately 5 mm to approximately 100 mm, the height H_{1b} can vary from approximately 5 mm to approximately 20 mm, and the width W_{1b} can vary from approximately 5 mm to approximately 50 mm. The middle subassembly 473 can have a length L_{2b}, a height H_{2b}, and a width W_{2b} associated therewith. The length L_{2b} can vary from approximately 5 mm to approximately 50 mm, the height H_{2b} can vary from approximately 5 mm to approximately 20 mm, and the width W_{2b} can vary from approximately 5 mm to approximately 50 mm. The lower subassembly 474 can have a length L_{3b} a height H_{3b}, and a width W_{3b} associated therewith. The length L_{3b} can vary from approximately 5 mm to approximately 50 mm, the height H_{3b} can vary from approximately 5 mm to approximately 20 mm, and the width W_{3b} can vary from approximately 5 mm to approximately 50 mm.

The operating temperature for the temperature control units (490a, 490b, and 490c) can range from approximately minus 30 degrees Celsius to approximately 150 degrees Celsius. The operating temperature for the temperature control units (490a, 490b, and 490c) can be different and can be dependent on the type and amount of residue. The operating temperature within the thermal control space 423b can range from approximately minus 20 degrees Celsius to approximately 145 degrees Celsius. The temperature at the wafer edge can range from approximately minus 10 degrees Celsius to approximately 140 degrees Celsius, and the temperature at the wafer edge can be substantially different from the temperature at the interior of the wafer 401. The temperature of the edge-bead material 402 can range from approximately minus 10 degrees Celsius to approximately 140 degrees Celsius so that the edge-bead material 402 can be efficiently removed.

In various examples, the temperature control units can include electrical, resistance, thermoelectric, and/or optical heating elements (not shown). In other examples, Nitrogen or any other gas can be used for controlling the temperature at the wafer edge and can be provided through one or more flow ports (not shown).

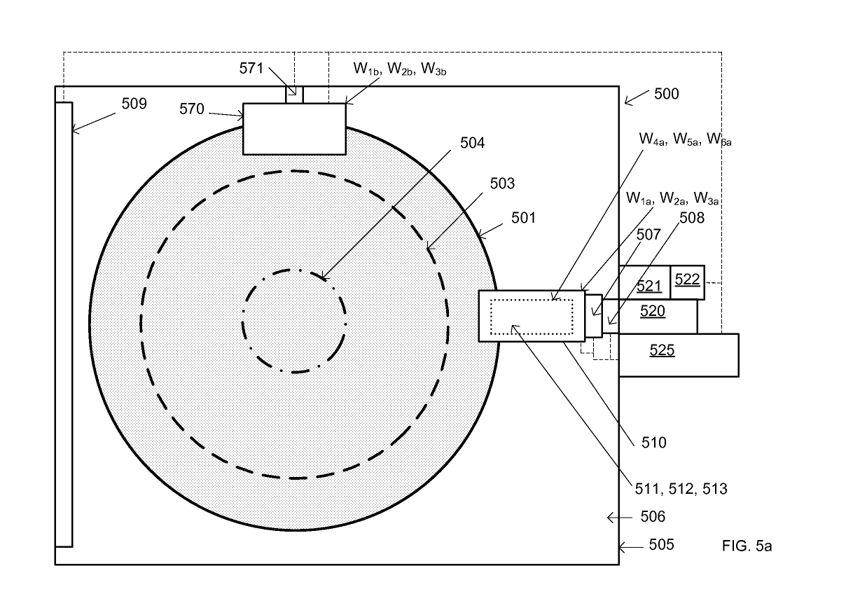

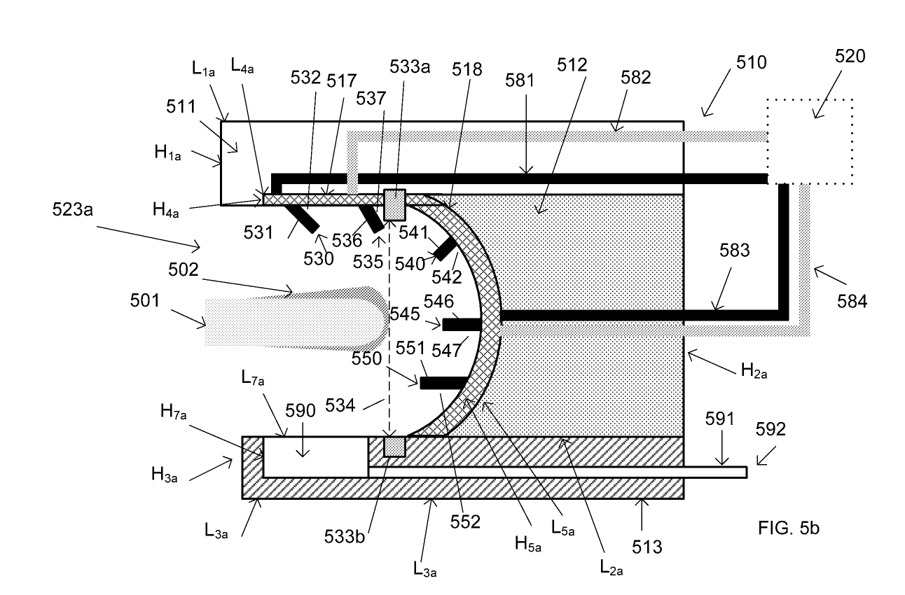

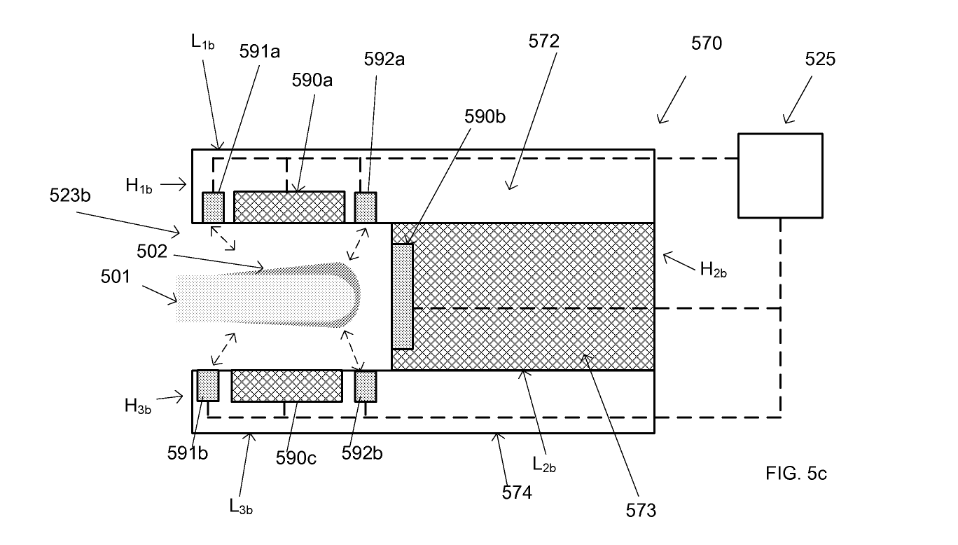

FIGS. 5a-5c show exemplary schematic views of a edge-bead removal system in accordance with embodiments of the invention. In the illustrated embodiment, an exemplary edge-bead removal system 500 is shown that comprises a processing chamber 505, a wafer table 503 for supporting a wafer 501, and a translation unit 504 coupled to the wafer table 503 and to the processing chamber 505. The wafer table 503 can include a vacuum system (not shown) for coupling the wafer 501 to the wafer table 503. The translation unit 504 can be used to align the wafer table 503 in one or more directions and can be used to rotate the wafer table. For example, revolution rates can vary from approximately 0.10 rpm to approximately 6,000 rpm; the revolution rate accuracy can vary from approximately +1 rpm to approximately −1 rpm; and the acceleration rates can vary from approximately 100 rpm/sec to approximately 50,000 rpm/sec.

The edge-bead removal subsystem 510 can be coupled to the processing chamber 505 using first coupling element 507 and second coupling element 508. For example, the first coupling element 507 and second coupling element 508 can be configured as a flexible arm. Edge-bead removal subsystem 510 can comprise an upper cleaning assembly 511, a middle cleaning assembly 512, and a lower cleaning assembly 513 that can be used to form a cleaning space 523a. The edge-bead removal system 500 can also include a supply subsystem 520 coupled to the edge-bead removal subsystem 510 and to the processing chamber 505. The supply subsystem 520 can be configured to provide processing fluids and gasses at the correct temperatures and flow rates.

The upper cleaning assembly 511 can have a length L₁ₐ, a height H₁ₐ, and a width W₁ₐ associated therewith. The length L₁ₐ can vary from approximately 5 mm to approximately 100 mm, the height H₁ₐ can vary from approximately 5 mm to approximately 20 mm, and the width W₁ₐ can vary from approximately 5 mm to approximately 50 mm. The middle cleaning assembly 512 can have a length L₂ₐ, a height H₂ₐ, and a width W₂ₐ associated therewith. The length L₂ₐ can vary from approximately 5 mm to approximately 50 mm, the height H₂ₐ can vary from approximately 5 mm to approximately 20 mm, and the width W₂ₐ can vary from approximately 5 mm to approximately 50 mm. The lower cleaning assembly 513 can have a length L₃ₐ a height H₃ₐ, and a width W₃ₐ associated therewith. The length L₃ₐ can vary from approximately 5 mm to approximately 50 mm, the height H₃ₐ can vary from approximately 5 mm to approximately 20 mm, and the width W₃ₐ can vary from approximately 5 mm to approximately 50 mm.

The edge-bead removal system 500 can include a temperature control subsystem 570, and the temperature control subsystem 570 can be coupled to the processing chamber 505 at a first location using one or more coupling elements 571. For example, the one or more coupling elements 571 can be configured as flexible arms. A more detailed view of an exemplary temperature control subsystem 570 is shown in FIG. 5c.

The processing chamber 505 can include one or more exhaust ports 521 coupled to the process space 506. For example, the exhaust port 521 may comprise one or more valves (not shown) and/or one or more exhaust sensors (not shown). Those skilled in the art will recognize that the one or more valves may be used for controlling flow in and/or out of the process space 506, and one or more exhaust sensors may be used for determining the processing state for the edge-bead removal system 500. In addition, one or more of the exhaust ports 521 may be coupled to an evacuation unit (not shown) and/or an exhaust system (not shown) using flexible hoses/tubes/pipes/conduits. Exhaust port 521 can be used to exhaust cleaning and/or other processing gasses that must be removed from the process space 506.

Processing chamber 505 can include a wafer transfer port 509 that can be opened during wafer transfer procedures and closed during wafer processing.

The edge-bead removal system 500 can comprise one or more recovery systems 522, and the recovery system 522 can be configured to analyze, filter, re-use and/or remove one or more processing fluids. For example, some solvents may be re-used.

In addition, the edge-bead removal system 500 can include a controller 525 that can be coupled to the wafer table 503, the translation unit 504, the processing chamber 505, the edge-bead removal subsystem 510, the first coupling element 507, the second coupling element 508, the supply subsystem 520, exhaust port 521, recovery system 522 a temperature control subsystem 570, coupling elements 571, and the wafer transfer port 509. Alternatively, other configurations may be used.

Referring to FIG. 5b, a simplified exploded view is shown for an exemplary edge-bead removal subsystem 510. In the exemplary exploded view, a portion of a wafer 501 is shown along with an exemplary portion of a edge-bead material 502. Alternatively, the shape, size, and position of the edge-bead material can be different.

In the illustrated embodiment, a first flow controller 517 is shown in an exploded view of the upper cleaning assembly 511, and a second flow controller 518 is shown in an exploded view of the middle cleaning assembly 512. In addition, an upper sensor unit 533a is shown coupled to the upper cleaning assembly 511, and a lower sensor unit 533b is shown coupled to the lower cleaning assembly 513. The upper sensor unit 533a and the lower sensor unit 533b can be used to determine processing states, positions, thicknesses, temperatures, pressures, flow rates, chemistries, spin rates, acceleration rates, residues, or particles, or any combination thereof.

The upper cleaning assembly 511 can include one or more first flow controllers 517 that can be coupled to a first supply line 581, and a second supply line 582. In various embodiments, one or more of the supply lines (581 and 582) can be operated in a supply mode or in an exhaust mode. In addition, the first flow controller 517 can be coupled to a first flow port 530, and a second flow port 535, and one or more of the flow ports (530 and 535) can be operated as input ports or output ports at various times during processing. In alternate embodiments, different numbers of flow controllers, different numbers of supply lines, and different numbers of flow ports can be used. The first flow controller 517 can monitor and control the first supply line 581, the second supply line 582, the first flow port 530, and the second flow port 535 as required. The first flow port 530 can have a first shape 531 and a first angle 532 associated therewith, and the second flow port 535 can have a second shape 536 and a second angle 537 associated therewith. Alternatively, other shapes and angles may be used.

One or more of the shapes (531 and 536) can be rectangular, cylindrical, and/or tapered, and the angles (532 and 537) can range from approximately 10 degrees to approximately 170 degrees.

The middle cleaning assembly 512 can include one or more second flow controllers 518 that can be coupled to a third supply line 583, and a fourth supply line 584. In various embodiments, one or more of the supply lines (583 and 584) can be operated in a supply mode or an exhaust mode. In addition, the second flow controller 518 can be coupled to a third flow port 540, a fourth flow port 545, and a fifth flow port 550, and one or more of the flow ports (540, 545, and 550) can be operated as input ports or output ports at various times during processing. In alternate embodiments, different numbers of flow controllers, different numbers of supply lines, and different numbers of flow ports can be used.

The second flow controller 518 can monitor and control the third supply line 583, the fourth supply line 584, the third flow port 540, the fourth flow port 545, and the fifth flow port 550 as required. The third flow port 540 can have a third shape 541 and a third angle 542 associated therewith, the fourth flow port 545 can have a fourth shape 546 and a fourth angle 547 associated therewith, and the fifth flow port 550 can have a fifth shape 551 and a fifth angle 552 associated therewith. Alternatively, other configurations may be used.

One or more of the shapes (541, 546, and 551) can be rectangular, cylindrical, and/or tapered, and the angles (542, 547, and 552) can range from approximately 10 degrees to approximately 170 degrees.

The first flow controller 517 can have a length L₄ₐ, a height H₄ₐ, and a width W₄ₐ associated therewith. The length L₄ₐ can vary from approximately 10 mm to approximately 50 mm, the height H₄ₐ can vary from approximately 4 mm to approximately 10 mm, and the width W₄ₐ can vary from approximately 10 mm to approximately 50 mm. The second flow controller 518 can have a length L₅ₐ, a height H₅ₐ, and a width W₅ₐ associated therewith. The length L₅ₐ can vary from approximately 10 mm to approximately 50 mm, the height H₅ₐ can vary from approximately 4 mm to approximately 10 mm, and the width W₅ₐ can vary from approximately 10 mm to approximately 50 mm.

One or more of the flow ports (530, 535, 540, 545, and 550) can have outside diameters that can range from approximately 0.5 mm to approximately 5.0 mm, inside diameters that can range from approximately 0.1 mm to approximately 2.0 mm, and lengths that range from approximately 2 mm to approximately 10 mm. The dimensions can be dependent upon the wafer type, the type of residue being removed, and the chemistries being used. In addition, the distance between the tip of a flow port and the wafer 501 can be changed during processing as the edge-bead removal subsystem 510 is moved with respect to the edge of the wafer. The minimum separation distance can be dependent upon the wafer type, the type of residue being removed, and/or the chemistries being used, and can vary from approximately 0.5 mm to approximately 1.5 mm. In other examples, one or more of the flow ports (530, 535, 540, 545, and 550) can include a nozzle, and a nozzle can have a diameter that ranges from approximately 0.1 mm to approximately 2.0 mm, can have a length that ranges from approximately 2 mm to approximately 10 mm.

In some cleaning procedures, Propylene Glycol Monomethyl Ether Acetate can be used as cleaning fluids or rinsing agent. In other removal procedures, other solvents or blends of solvents or liquids can be used based on the type and amount of undesired film. In addition, cleaning fluids or rinsing agents can include the following as single materials or blends: N-Butyl Acetate, Cyclohexanone, Ethyl Lactate, Acetone, Isopropyl alcohol, 4-methyl 2-Pentanone, Gamma Butyl Lactone. In other cleaning procedures, water or diluted HF or diluted sulfuric acid/hydrogen peroxide can be used for removing film material and/or edge-bead material.

The lower cleaning assembly 513 can include one or more collection devices 590 and each collection device 590 can have one or more inputs and one or more outputs. In some embodiments, a collection device 590 can be coupled to a return line 591 and return line output 592 can be coupled to a recovery system (not shown), and the collection device 590 may be used to collect and remove cleaning fluids, rinsing agents, drying agents, chemical agents, and/or reaction products. The collection device 590 can have a length L₇ₐ, a height H₇ₐ, and a width W₇ₐ associated therewith. The length L₇ₐ can vary from approximately 1 mm to approximately 10 mm, the height H₇ₐ can vary from approximately 1 mm to approximately 10 mm, and the width W₇ₐ can vary from approximately 1 mm to approximately 10 mm.

Referring to FIG. 5c, a simplified exploded view is shown of another exemplary temperature control subsystem 570. In the exemplary exploded view, a thermal control space 523b in shown, and a portion of a wafer 501 is shown along with an exemplary portion of a edge-bead material 502 in the thermal control space 523b. Alternatively, the shape, size, and position of the edge-bead material can be different.

In the illustrated embodiment, an exploded view of a first temperature control unit 590a is shown in the upper subassembly 572, an exploded view of a second temperature control unit 590b is shown in the middle subassembly 573, and an exploded view of a third temperature control unit 590c is shown in the lower subassembly 574. The upper subassembly 572 can include a first sensor 591a and a second sensor 592a, and sensors (591a and 592a) can measure positions, thicknesses, temperatures, pressures, flow rates, chemistries, spin rates, acceleration rates, residues, and particles. The first temperature control unit 590a, the first sensor 591a, and the second sensor 592a can be coupled to the controller 525. The controller 525 can monitor and control the first temperature control unit 590a, the first sensor 591a, and the second sensor 592a. Alternatively, other configurations may be used.

The middle subassembly 573 can include the second temperature control unit 590b, and the second temperature control unit 590b can be coupled to the controller 525, so controller 525 can monitor and control the second temperature control unit 590b. Alternatively, the middle subassembly 573 may include sensors (not shown).

The lower subassembly 574 can include a third sensor 591b and a fourth sensor 592b, and sensors (591b and 592b) can determine processing states, positions, thicknesses, temperatures, pressures, flow rates, chemistries, spin rates, acceleration rates, residues, and particles. The third temperature control unit 590c, the third sensor 591b, and the fourth sensor 592b can be coupled to the controller 525. The controller 525 can monitor and control the third temperature control unit 590c, the third sensor 591b, and the fourth sensor 592b. Alternatively, other configurations may be used.

The upper subassembly 572 can have a length L_{1b}, a height H_{1b}, and a width W_{1b} associated therewith. The length L_{1b} can vary from approximately 5 mm to approximately 100 mm, the height H_{1b} can vary from approximately 5 mm to approximately 20 mm, and the width W_{1b} can vary from approximately 5 mm to approximately 50 mm. The middle subassembly 573 can have a length L_{2b}, a height H_{2b}, and a width W_{2b} associated therewith. The length L_{2b} can vary from approximately 5 mm to approximately 50 mm, the height H_{2b} can vary from approximately 5 mm to approximately 20 mm, and the width W_{2b} can vary from approximately 5 mm to approximately 50 mm. The lower subassembly 574 can have a length L_{3b} a height H_{3b}, and a width W_{3b} associated therewith. The length L_{3b} can vary from approximately 5 mm to approximately 50 mm, the height H_{3b} can vary from approximately 5 mm to approximately 20 mm, and the width W_{3b} can vary from approximately 5 mm to approximately 50 mm.

The operating temperature for the temperature control units (590a, 590b, and 590c) can range from approximately minus 30 degrees Celsius to approximately 150 degrees Celsius. The operating temperature for the temperature control units (590a, 590b, and 590c) can be different and can be dependent on the type and amount of residue. The operating temperature within the thermal control space 523b can range from approximately minus 20 degrees Celsius to approximately 145 degrees Celsius. The temperature at the wafer edge can range from approximately minus 10 degrees Celsius to approximately 140 degrees Celsius, and the temperature at the wafer edge can be substantially different from the temperature at the interior of the wafer 501. The temperature of the edge-bead material 502 can range from approximately minus 10 degrees Celsius to approximately 140 degrees Celsius so that the edge-bead material 502 can be efficiently removed.

In various examples, the temperature control units can include electrical, resistance, thermoelectric, and/or optical heating elements (not shown). In other examples, Nitrogen or any other gas can be used for controlling the temperature at the wafer edge and can be provided through one or more flow ports (not shown).

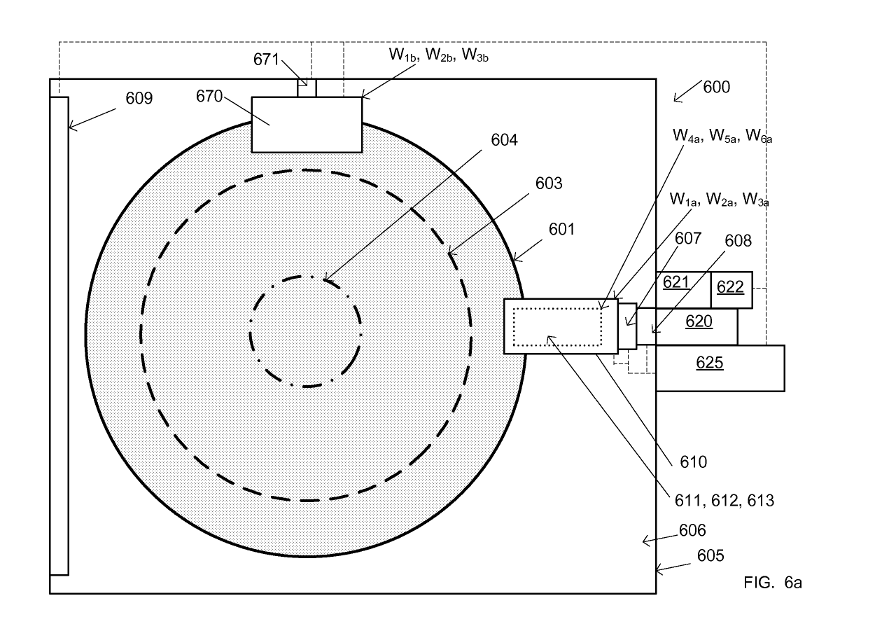

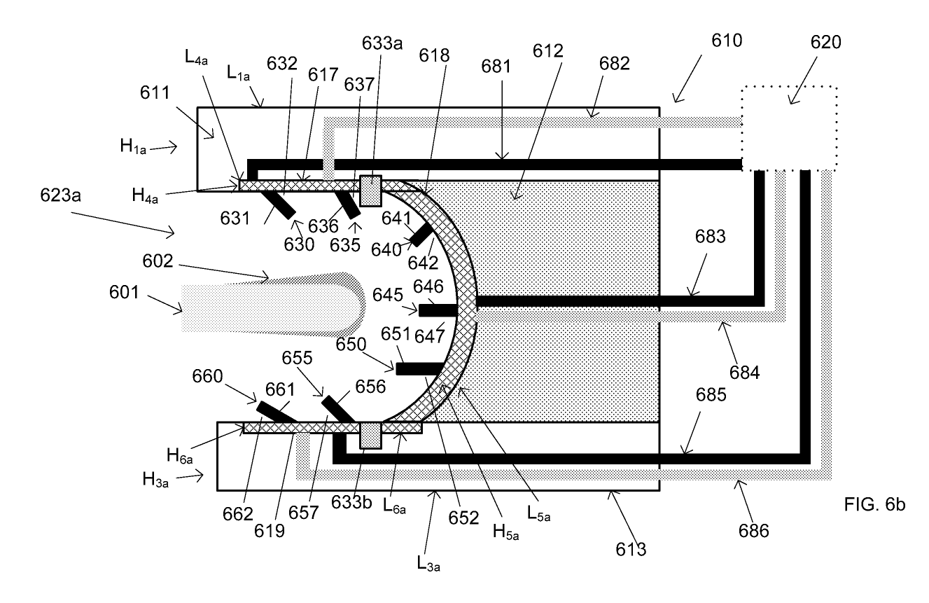

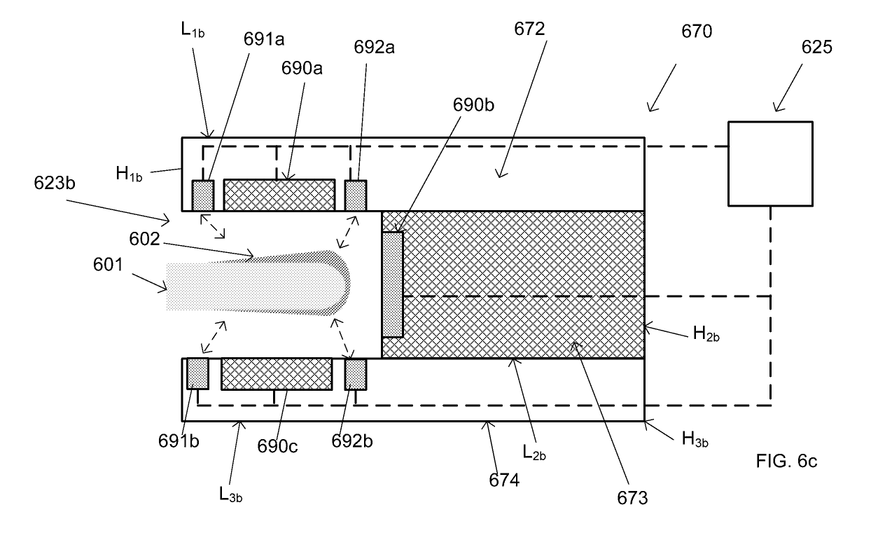

FIGS. 6a-6c show exemplary schematic views of an additional edge-bead removal system in accordance with embodiments of the invention. In the illustrated embodiment, an exemplary edge-bead removal system 600 is shown that comprises a processing chamber 605, a wafer table 603 for supporting a wafer 601, and a translation unit 604 coupled to the wafer table 603 and to the processing chamber 605. The wafer table 603 can include a vacuum system (not shown) for coupling the wafer 601 to the wafer table 603. The translation unit 604 can be used to align the wafer table 603 in one or more directions and can be used to rotate the wafer table. For example, revolution rates can vary from approximately 0.10 rpm to approximately 6,000 rpm; the revolution rate accuracy can vary from approximately +1 rpm to approximately −1 rpm; and the acceleration rates can vary from approximately 100 rpm/sec to approximately 50,000 rpm/sec.

The edge-bead removal subsystem 610 can be coupled to the processing chamber 605 using first coupling element 607 and second coupling element 608. For example, the first coupling element 607 and second coupling element 608 can be configured as a flexible arm. Edge-bead removal subsystem 610 can comprise an upper cleaning assembly 611, a middle cleaning assembly 612, and a lower cleaning assembly 613 that can be used to form a cleaning space 623a. The edge-bead removal system 600 can also include a supply subsystem 620 coupled to the edge-bead removal subsystem 610 and to the processing chamber 605. The supply subsystem 620 can be configured to provide processing fluids and gasses at the correct temperatures and flow rates.

The upper cleaning assembly 611 can have a length L₁ₐ, a height H₁ₐ, and a width W₁ₐ associated therewith. The length L₁ₐ can vary from approximately 5 mm to approximately 100 mm, the height H₁ₐ can vary from approximately 5 mm to approximately 20 mm, and the width W₁ₐ can vary from approximately 5 mm to approximately 50 mm. The middle cleaning assembly 612 can have a length L₂ₐ, a height H₂ₐ, and a width W₂ₐ associated therewith. The length L₂ₐ can vary from approximately 5 mm to approximately 50 mm, the height H₂ₐ can vary from approximately 5 mm to approximately 20 mm, and the width W₂ₐ can vary from approximately 5 mm to approximately 50 mm. The lower cleaning assembly 613 can have a length L₃ₐ a height H₃ₐ, and a width W₃ₐ associated therewith. The length L₃ₐ can vary from approximately 5 mm to approximately 50 mm, the height H₃ₐ can vary from approximately 5 mm to approximately 20 mm, and the width W₃ₐ can vary from approximately 5 mm to approximately 50 mm.

The edge-bead removal system 600 can include a temperature control subsystem 670, and the temperature control subsystem 670 can be coupled to the processing chamber 605 at a first location using one or more coupling elements 671. For example, the one or more coupling elements 671 can be configured as flexible arms. A more detailed view of an exemplary temperature control subsystem 670 is shown in FIG. 6c.

The processing chamber 605 can include one or more exhaust ports 621 coupled to the process space 606. For example, the exhaust port 621 may comprise one or more valves (not shown) and/or one or more exhaust sensors (not shown). Those skilled in the art will recognize that the one or more valves may be used for controlling flow in and/or out of the process space 606, and one or more exhaust sensors may be used for determining the processing state for the edge-bead removal system 600. In addition, one or more of the exhaust ports 621 may be coupled to an evacuation unit (not shown) and/or an exhaust system (not shown) using flexible hoses/tubes/pipes/conduits. Exhaust port 621 can be used to exhaust cleaning and/or other processing gasses that must be removed from the process space 606.

Processing chamber 605 can include a wafer transfer port 609 that can be opened during wafer transfer procedures and closed during wafer processing.

The edge-bead removal system 600 can comprise one or more recovery systems 622, and the recovery system 622 can be configured to analyze, filter, re-use and/or remove one or more processing fluids. For example, some solvents may be re-used.

In addition, the edge-bead removal system 600 can include a controller 625 that can be coupled to the wafer table 603, the translation unit 604, the processing chamber 605, the edge-bead removal subsystem 610, the first coupling element 607, the second coupling element 608, the supply subsystem 620, exhaust port 621, recovery system 622 a temperature control subsystem 670, coupling elements 671, and the wafer transfer port 609. Alternatively, other configurations may be used.

Referring to FIG. 6b, a simplified exploded view is shown for an exemplary edge-bead removal subsystem 610. In the exemplary exploded view, a portion of a wafer 601 is shown along with an exemplary portion of edge-bead material 602. Alternatively, the shape, size, and position of the edge-bead material can be different.

In the illustrated embodiment, a first flow controller 617 is shown in an exploded view of the upper cleaning assembly 611, and a second flow controller 618 is shown in an exploded view of the middle cleaning assembly 612. In addition, an upper sensor unit 633a is shown coupled to the upper cleaning assembly 611, and a lower sensor unit 633b is shown coupled to the lower cleaning assembly 613. The upper sensor unit 633a and the lower sensor unit 633b can be used to determine processing states, positions, thicknesses, temperatures, pressures, flow rates, chemistries, spin rates, acceleration rates, residues, or particles, or any combination thereof.

The upper cleaning assembly 611 can include one or more first flow controllers 617 that can be coupled to a first supply line 681, and a second supply line 682. In various embodiments, one or more of the supply lines (681 and 682) can be operated in a supply mode or in an exhaust mode. In addition, the first flow controller 617 can be coupled to a first flow port 630, and a second flow port 635, and one or more of the flow ports (630 and 635) can be operated as input ports or output ports at various times during processing. In alternate embodiments, different numbers of flow controllers, different numbers of supply lines, and different numbers of flow ports can be used. The first flow controller 617 can monitor and control the first supply line 681, the second supply line 682, the first flow port 630, and the second flow port 635 as required. The first flow port 630 can have a first shape 631 and a first angle 632 associated therewith, and the second flow port 635 can have a second shape 636 and a second angle 637 associated therewith. Alternatively, other shapes and angles may be used.

The middle cleaning assembly 612 can include one or more second flow controllers 618 that can be coupled to a third supply line 683, and a fourth supply line 684. In various embodiments, one or more of the supply lines (683 and 684) can be operated in a supply mode or an exhaust mode. In addition, the second flow controller 618 can be coupled to a third flow port 640, a fourth flow port 645, and a fifth flow port 650, and one or more of the flow ports (640, 645, and 650) can be operated as input ports or output ports at various times during processing. In alternate embodiments, different numbers of flow controllers, different numbers of supply lines, and different numbers of flow ports can be used.

The second flow controller 618 can monitor and control the third supply line 683, the fourth supply line 684, the third flow port 640, the fourth flow port 645, and the fifth flow port 650 as required. The third flow port 640 can have a third shape 641 and a third angle 642 associated therewith, the fourth flow port 645 can have a fourth shape 646 and a fourth angle 647 associated therewith, and the fifth flow port 650 can have a fifth shape 651 and a fifth angle 652 associated therewith. Alternatively, other configurations may be used.

The first flow controller 617 can have a length L₄ₐ, a height H₄ₐ, and a width W₄ₐ associated therewith. The length L₄ₐ can vary from approximately 10 mm to approximately 50 mm, the height H₄ₐ can vary from approximately 4 mm to approximately 10 mm, and the width W₄ₐ can vary from approximately 10 mm to approximately 50 mm. The second flow controller 618 can have a length L₅ₐ, a height H₅ₐ, and a width W₅ₐ associated therewith. The length L₅ₐ can vary from approximately 10 mm to approximately 50 mm, the height H₅ₐ can vary from approximately 4 mm to approximately 10 mm, and the width W₅ₐ can vary from approximately 10 mm to approximately 50 mm.

The lower cleaning assembly 613 can include one or more third flow controllers 619 that can be coupled to a fifth supply line 685, and a sixth supply line 686. In various embodiments, one or more of the supply lines (685 and 686) can be operated in a supply mode or an exhaust mode. In addition, the third flow controller 619 can be coupled to a sixth flow port 655, and a seventh flow port 660, and one or more of the flow ports (655 and 660) can be operated as input ports or output ports at various times during processing. In alternate embodiments, different numbers of flow controllers, different numbers of supply lines, and different numbers of flow ports can be used.

The third flow controller 619 can monitor and control the fifth supply line 685, the sixth supply line 686, the sixth flow port 655, and the seventh flow port 660 as required. The sixth flow port 655 can have a sixth shape 656 and a sixth angle 657 associated therewith, and the seventh flow port 660 can have a seventh shape 661 and a seventh angle 662 associated therewith. Alternatively, other configurations may be used.

The first flow controller 617 can have a length L₄ₐ, a height H₄ₐ, and a width W₄ₐ associated therewith. The length L₄ₐ can vary from approximately 10 mm to approximately 50 mm, the height H₄ₐ can vary from approximately 4 mm to approximately 10 mm, and the width W₄ₐ can vary from approximately 10 mm to approximately 50 mm. The second flow controller 618 can have a length L₅ₐ, a height H₅ₐ, and a width W₅ₐ associated therewith. The length L₅ₐ can vary from approximately 10 mm to approximately 50 mm, the height H₅ₐ can vary from approximately 4 mm to approximately 10 mm, and the width W₅ₐ can vary from approximately 10 mm to approximately 50 mm. The third flow controller 619 can have a length L₆ₐ, a height H₆ₐ, and a width W₆ₐ associated therewith. The length L₆ₐ can vary from approximately 10 mm to approximately 50 mm, the height H₆ₐ can vary from approximately 4 mm to approximately 10 mm, and the width W₆ₐ can vary from approximately 10 mm to approximately 50 mm.

One or more of the flow ports (630, 635, 640, 645, 650, 655, and 660) can have outside diameters that can range from approximately 0.5 mm to approximately 5.0 mm, inside diameters that can range from approximately 0.1 mm to approximately 2.0 mm, and lengths that range from approximately 2 mm to approximately 10 mm. The dimensions can be dependent upon the wafer type, the type of residue being removed, and the chemistries being used. In addition, the distance between the tip of a flow port and the wafer 601 can be changed during processing as the edge-bead removal subsystem 610 is moved with respect to the edge of the wafer. The minimum separation distance can be dependent upon the wafer type, the type of residue being removed, and/or the chemistries being used, and can vary from approximately 0.5 mm to approximately 1.5 mm. In other examples, one or more of the flow ports (630, 635, 640, 645, 650, 655, and 660) can include a nozzle, and a nozzle can have a diameter that ranges from approximately 0.1 mm to approximately 2.0 mm, can have a length that ranges from approximately 2 mm to approximately 10 mm.

In some cleaning procedures, Propylene Glycol Monomethyl Ether Acetate can be used as cleaning fluids or rinsing agent. In other removal procedures, other solvents or blends of solvents or liquids can be used based on the type and amount of undesired film. In addition, cleaning fluids or rinsing agents can include the following as single materials or blends: N-Butyl Acetate, Cyclohexanone, Ethyl Lactate, Acetone, Isopropyl alcohol, 4-methyl 2-Pentanone, Gamma Butyl Lactone. In other cleaning procedures, water or diluted HF or diluted sulfuric acid/hydrogen peroxide can be used for removing film material and/or edge-bead material.

Referring to FIG. 6c, a simplified exploded view is shown of an exemplary temperature control subsystem 670. In the exemplary exploded view, a thermal control space 623b in shown, and a portion of a wafer 601 is shown along with an exemplary portion of edge-bead material 602 in the thermal control space 623b. Alternatively, the shape, size, and position of the edge-bead can be different.

In the illustrated embodiment, an exploded view of a first temperature control unit 690a is shown in the upper subassembly 672, an exploded view of a second temperature control unit 690b is shown in the middle subassembly 673, and an exploded view of a third temperature control unit 690c is shown in the lower subassembly 674. The upper subassembly 672 can include a first sensor 691a and a second sensor 692a, and sensors (691a and 692a) can measure positions, thicknesses, temperatures, pressures, flow rates, chemistries, spin rates, acceleration rates, residues, and particles. The first temperature control unit 690a, the first sensor 691a, and the second sensor 692a can be coupled to the controller 625. The controller 625 can monitor and control the first temperature control unit 690a, the first sensor 691a, and the second sensor 692a. Alternatively, other configurations may be used.

The middle subassembly 673 can include the second temperature control unit 690b, and the second temperature control unit 690b can be coupled to the controller 625, so controller 625 can monitor and control the second temperature control unit 690b. Alternatively, the middle subassembly 673 may include sensors (not shown).

The lower subassembly 674 can include a third sensor 691b and a fourth sensor 692b, and sensors (691b and 692b) can determine processing states, positions, thicknesses, temperatures, pressures, flow rates, chemistries, spin rates, acceleration rates, residues, and particles. The third temperature control unit 690c, the third sensor 691b, and the fourth sensor 692b can be coupled to the controller 625. The controller 625 can monitor and control the third temperature control unit 690c, the third sensor 691b, and the fourth sensor 692b. Alternatively, other configurations may be used.

The upper subassembly 672 can have a length L_{1b}, a height H_{1b}, and a width W_{1b} associated therewith. The length L_{1b} can vary from approximately 5 mm to approximately 100 mm, the height H_{1b} can vary from approximately 5 mm to approximately 20 mm, and the width W_{1b} can vary from approximately 5 mm to approximately 50 mm. The middle subassembly 673 can have a length L_{2b}, a height H_{2b}, and a width W_{2b} associated therewith. The length L_{2b} can vary from approximately 5 mm to approximately 50 mm, the height H_{2b} can vary from approximately 5 mm to approximately 20 mm, and the width W_{2b} can vary from approximately 5 mm to approximately 50 mm. The lower subassembly 674 can have a length L_{3b} a height H_{3b}, and a width W_{3b} associated therewith. The length L_{3b} can vary from approximately 5 mm to approximately 50 mm, the height H_{3b} can vary from approximately 5 mm to approximately 20 mm, and the width W_{3b} can vary from approximately 5 mm to approximately 50 mm.

The operating temperature for the temperature control units (690a, 690b, and 690c) can range from approximately minus 30 degrees Celsius to approximately 150 degrees Celsius. The operating temperature for the temperature control units (690a, 690b, and 690c) can be different and can be dependent on the type and amount of residue. The operating temperature within the thermal control space 623b can range from approximately minus 20 degrees Celsius to approximately 145 degrees Celsius. The temperature at the wafer edge can range from approximately minus 10 degrees Celsius to approximately 140 degrees Celsius, and the temperature at the wafer edge can be substantially different from the temperature at the interior of the wafer 601. The temperature of the edge-bead material 602 can range from approximately minus 10 degrees Celsius to approximately 140 degrees Celsius so that the edge-bead material 602 can be efficiently removed.

In various examples, the temperature control units can include electrical, resistance, thermoelectric, and/or optical heating elements (not shown). In other examples, Nitrogen or any other gas can be used for controlling the temperature at the wafer edge and can be provided through one or more flow ports

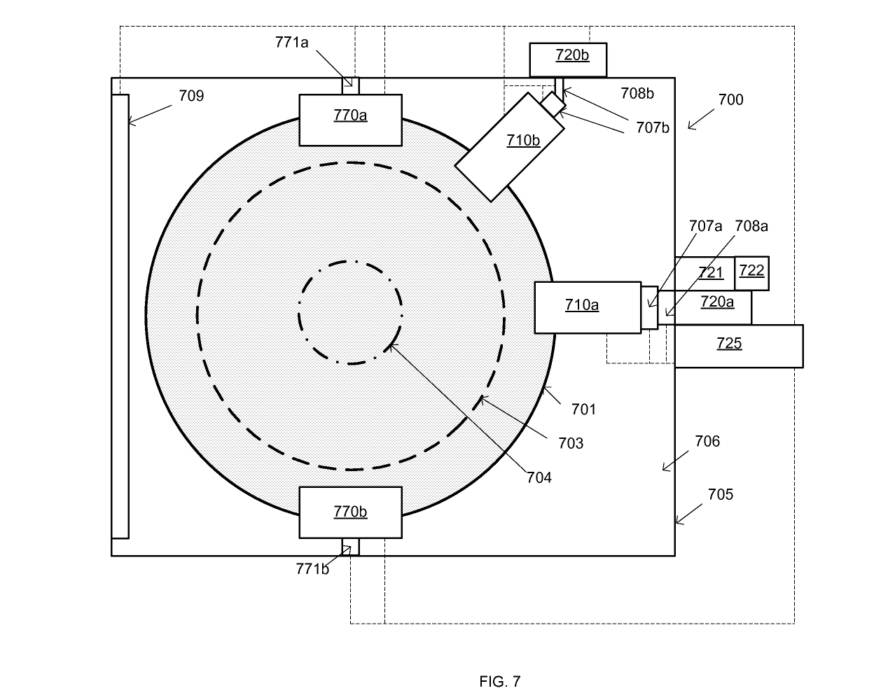

FIG. 7 shows another exemplary configuration of an additional edge-bead removal system in accordance with embodiments of the invention. In the illustrated embodiment, an exemplary edge-bead removal system 700 is shown that comprises a processing chamber 705, a wafer table 703 for supporting a wafer 701, and a translation unit 704 coupled to the wafer table 703 and to the processing chamber 705. The wafer table 703 can include a vacuum system (not shown) for coupling the wafer 701 to the wafer table 703. The translation unit 704 can be used to align the wafer table 703 in one or more directions and can be used to rotate the wafer table. For example, revolution rates can vary for approximately 0.10 rpm to approximately 6,000 rpm; the revolution rate accuracy can vary from approximately +1 rpm to approximately −1 rpm; and the acceleration rates can vary from approximately 100 rpm/sec to approximately 50,000 rpm/sec.

A first edge-bead removal subsystem 710a can be coupled to the processing chamber 705 at a first location using first coupling element 707a and second coupling element 708a. For example, the first coupling element 707a and second coupling element 708a can be configured as a flexible arm. The first edge-bead removal subsystem 710a can comprise one or more cleaning assemblies as shown in FIGS. 4b, 5b, and 6b. Alternatively, different locations and a different number of devices may be used. The edge-bead removal system 700 can include a first supply subsystem 720a coupled to the first edge-bead removal subsystem 710a and to the processing chamber 705. The first supply subsystem 720a can be configured to provide a first set of processing fluids and gasses at the correct temperatures and flow rates.

A second edge-bead removal subsystem 710b can be coupled to the processing chamber 705 at a second location using first coupling element 707b and second coupling element 708b. For example, the first coupling element 707b and second coupling element 708b can be configured as a flexible arm. The second edge-bead removal subsystem 710b can comprise one or more cleaning assemblies as shown in FIGS. 4b, 5b, and 6b. Alternatively, different locations and a different number of devices may be used. The edge-bead removal system 700 can include a second supply subsystem 720b coupled to the second edge-bead removal subsystem 710b and to the processing chamber 705. The second supply subsystem 720b can be configured to provide a second set of processing fluids and gasses at the correct temperatures and flow rates. Alternatively, separate supply subsystems may not be required.

The edge-bead removal system 700 can include a first temperature control subsystem 770a, and the first temperature control subsystem 770a can be coupled to the processing chamber 705 at a first location using one or more coupling elements 771a. For example, the one or more coupling element 771a can be configured as a flexible arm. The first temperature control subsystem 770a can comprise one or more subassemblies as shown in FIGS. 4c, 5c, and 6c. In addition, the edge-bead removal system 700 can include a second temperature control subsystem 770b, and the second temperature control subsystem 770b can be coupled to the processing chamber 705 at a second location using one or more coupling elements 771b. For example, the one or more coupling element 771b can be configured as a flexible arm. Alternatively, different locations and a different number of devices may be used. Second temperature control subsystem 770b can comprise one or more subassemblies as shown in FIGS. 4c, 5c, and 6c.

The processing chamber 705 can include one or more exhaust ports 721 coupled to the process space 706. For example, the exhaust port 721 may comprise one or more valves (not shown) and/or one or more exhaust sensors (not shown). Those skilled in the art will recognize that the one or more valves may be used for controlling flow in and/or out of the process space 706, and one or more exhaust sensors may be used for determining the processing state for the edge-bead removal system 700. In addition, one or more of the exhaust ports 721 may be coupled to an evacuation unit (not shown) and/or an exhaust system (not shown) using flexible hoses. Exhaust port 721 can be used to exhaust cleaning and/or other processing gasses that must be removed from the process space 706. Port diameters can range from 0.2 mm to 10.0 mm.

Processing chamber 705 can include a wafer transfer port 709 that can be opened during wafer transfer procedures and closed during wafer processing.

The edge-bead removal system 700 can comprise one or more recovery systems 722, and the recovery system 722 can be configured to analyze, filter, re-use and/or remove one or more processing fluids. For example, some solvents may be re-used.

In addition, the edge-bead removal system 700 can include a controller 725 that can be coupled to the wafer table 703, the translation unit 704, the processing chamber 705, the wafer transfer port 709, the exhaust port 721, the recovery system 722, the first edge-bead removal subsystem 710a, the first supply subsystem 720a, the second edge-bead removal subsystem 710b, the second supply subsystem 720b, the first temperature control subsystem 770a, the second temperature control subsystem 770b, and the coupling elements (707a, 707b, 708a, 708b, 771a, and 772b). Alternatively, other configurations may be used.

In alternate embodiments, a solvent bath (not shown) may be installed with the processing chamber 705, and may be used for storing one or more edge-bead removal subsystem (410, 510, and 610). For example, different edge-bead removal subsystems may be used as additional layers are added to the wafer. When installed, the solvent bath may be used to prevent changes in quality of residue removal process.

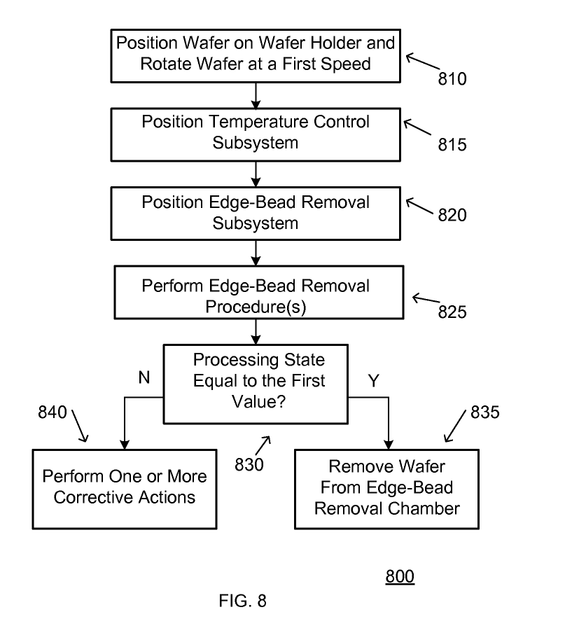

FIG. 8 illustrates a simplified process flow diagram for a method for using a edge-bead removal system according to embodiments of the invention. After a photoresist coating or ARC layer is etched, a edge-bead removal system can be used to remove edge-bead material, photoresist residue, antireflective residue or other polymer residues from the top edge, bevel and backside of the wafer.

In 810, a wafer can be positioned on a wafer holder, and vacuum techniques can be used to fix the wafer to the wafer holder. In some embodiments, an alignment procedure can be performed using a notch in the wafer. The wafer can be rotated on a wafer holder in a processing chamber at a first speed during a first time, and a first wafer position can be determined. The wafer can have an edge-bead on one or more outer surfaces, and feed forward data can be used to determine the type of edge-bead material and thickness of the edge-bead material. Alternatively, the edge-bead removal system can be used to determine the type of edge-bead material and thickness of the edge-bead material using sensors in the 410, 510, 610, 710, 470, 570, 670, or 770. For example, the rotational speed can range from 0 rpm to 1000 rpm.

In 815, the wafer and the wafer holder can be rotated at the first speed, and one or more temperature control subsystems can be positioned proximate a wafer edge. The temperature control subsystem can establish a first wafer edge temperature during the first time using an arm having one or more coupling elements.

The temperature control subsystem can be moved to a first thermal control position proximate the wafer edge, and the first thermal control position being determined using the first wafer position. In addition, the thermal control subsystem can be moved to one or more positions during processing.

In some procedures, the temperature control subsystem can provide heat to the wafer edge to raise the temperature of the edge portion of the wafer and the edge-bead material close to the edge of the wafer. In other procedures, the temperature control subsystem can provide a coolant gas to lower the temperature of the edge portion of the wafer and the edge-bead material close to the edge of the wafer.

In 820, one or more edge-bead removal subsystems can be positioned proximate a wafer surface. A edge-bead removal subsystem can be configured to provide a first set of fluids and/or gasses to a first cleaning space proximate the wafer edge using a first set of flow ports, and can be configured to remove a second set of fluids and/or gasses from the first cleaning space using a second set of flow ports.

In 825, one or more edge-bead removal procedures can be performed using the edge-bead removal subsystem, and the edge-bead material can be removed from the wafer. The edge-bead removal subsystem can be positioned at a first location proximate a first wafer surface during the first time, and the first location can be determined using the first wafer position, and/or the first thermal control position.

In some embodiments, a first set of cleaning fluids and/or gasses can be provided to a first set of wafer surfaces proximate the wafer edge using at least one first directed flow through one or more of the first set of flow ports and at least one second directed flows through one or more of the second set of flow ports during a second time, wherein the wafer is rotated at a second speed during the second time and the edge-bead removal subsystem is moved from the first location to a second location during the second time. In addition, a first set of residual fluids and/or gasses can be removed from one or more surfaces of the wafer proximate the wafer edge using one or more additional directed flows during the second time, and the first set of residual fluids and/or gasses can comprise edge-bead material. The edge-bead removal subsystem can be configured to provide the one or more additional directed flows away from the one or more surfaces of the wafer using one or more of the first flow ports and/or one or more of the second flow ports. Alternatively, the removal procedure can be performed using one or more exhaust ports and/or collection devices.

In 830, a first processing state can be determined for the wafer. The first processing state can be a first value when the edge-bead material is substantially all removed and can be a second value when the edge-bead material is partially removed.

In 835, the wafer can be removed from the processing chamber, if the first processing state is the first value.

In 840, one or more corrective actions can be performed, if the first processing state is the second value. For example, the corrective actions can include new cleaning steps, new rinsing steps, new drying steps, new inspection steps, and new measurement steps.

The amount and type of edge-bead material, the wafer material, the rotational speed, and the cleaning chemistries can be used to determine the optimum wafer edge temperature. For example, the edge-bead material can include polymer residue, photoresist material, low-k, ultra-low-k material, or metallic material, or combination thereof.

In 825, in some cases, one or more coupling elements can be used to position the edge-bead removal subsystem relative to the edge of the wafer.

In 825, in some embodiments, one or more flow controllers can be used to provide one or more cleaning fluids in one or more directed flows towards the wafer edge.

In alternate processing sequences, one or more rinsing and/or drying procedures can be performed. For example, one or more flow controllers can be used to provide one or more rinsing agents and/or drying agents in one or more other directed flows towards the wafer edge. The rinsing agents and/or drying agents can include liquids and gasses known in the art.

In 830, a query can be performed to determine if the edge-bead material has been removed. When the edge-bead material has not been removed, procedure 800 can branch to 840. When edge-bead material has been removed, procedure 800 can branch to 835.

In 835, the wafer can be removed from edge-bead removal system.

In 840, one or more corrective actions can be performed. For example, the wafer can be re-processed using the same or a different edge-bead removal procedure.

In one example, the edge-bead removal procedure can include the following steps: a1) positioning the edge-bead removal subsystem at a first location proximate a first wafer surface during the first time, wherein the first location is determined using the first wafer position and/or the first thermal control position; a2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, a removed first residual liquid and/or gas comprising a first portion of the edge-bead material; a3) positioning the edge-bead removal subsystem at a second location proximate the wafer edge during a third time, wherein the second location is determined using the first wafer position, the first thermal control position, or the first location, or a combination thereof; a4) providing a second cleaning fluid to the first cleaning space using one or more of the first set of flow ports and removing at least one second residual liquid and/or gas using one or more of the second set of flow ports during a fourth time, wherein the wafer is rotated at a fourth speed during the fourth time, the removed second residual liquid and/or gas comprising a second portion of the edge-bead material; and a5) inspecting at least one wafer surface during a fifth time. For example, inspection data, and measurement data can be used when determining the processing state.

In a second example, the edge-bead removal procedure can include the following steps: b1) positioning the edge-bead removal subsystem at a first location proximate a first wafer surface during the first time, wherein the first location is determined using the first wafer position and/or the first thermal control position; b2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, the removed first residual liquid and/or gas comprising a first portion of the edge-bead material; b3) positioning the edge-bead removal subsystem at a second location proximate the wafer edge during a third time, wherein the second location is determined using the first wafer position, the first thermal control position, or the first location, or a combination thereof; b4) providing a first rinsing agent to the first cleaning space using one or more of the first set of flow ports and removing at least one second residual liquid and/or gas using one or more of the second set of flow ports during a fourth time, wherein the wafer is rotated at a fourth speed during the fourth time, the removed second residual liquid and/or gas comprising a second portion of the edge-bead material; and b5) inspecting at least one wafer surface during a fifth time.

In a third example, the edge-bead removal procedure can include the following steps: c1) positioning the edge-bead removal subsystem at a first location proximate a first wafer surface during the first time, wherein the first location is determined using the first wafer position and/or the first thermal control position; c2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, the removed first residual liquid and/or gas comprising a first portion of the edge-bead material; c3) positioning the edge-bead removal subsystem at a second location proximate the wafer edge during a third time, wherein the second location is determined using the first wafer position, the first thermal control position, or the first location, or a combination thereof; c4) providing a first drying agent to the first cleaning space using one or more of the first set of flow ports and removing at least one second residual liquid and/or gas using one or more of the second set of flow ports during a fourth time, wherein the wafer is rotated at a fourth speed during the fourth time, the removed second residual liquid and/or gas comprising a second portion of the edge-bead material; and c5) inspecting at least one wafer surface during a fifth time.

In a fourth example, the edge-bead removal procedure can include the following steps: d1) positioning the edge-bead removal subsystem at a first location proximate a first wafer surface during the first time, wherein the first location is determined using the first wafer position and/or the first thermal control position; d2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, the removed first residual liquid and/or gas comprising a first portion of the edge-bead material; d3) establishing a second wafer edge temperature during a third time, wherein the temperature control subsystem is moved to a second thermal control position proximate the wafer edge, the second thermal control position being determined using the first wafer position, the first thermal control position, or the first location, or a combination thereof; d4) positioning the edge-bead removal subsystem at a second location proximate the wafer edge during the third time, wherein the second location is determined using the first wafer position, the first thermal control position, the second thermal control position, or the first location, or a combination thereof; d5) providing a second cleaning fluid to the first cleaning space using one or more of the first set of flow ports and removing at least one second residual liquid and/or gas using one or more of the second set of flow ports during a fourth time, wherein the wafer is rotated at a fourth speed during the fourth time, the removed second residual liquid and/or gas comprising a second portion of the edge-bead material; and d6) inspecting at least one wafer surface during a fifth time.

In a fifth example, the edge-bead removal procedure can include the following steps: e1) positioning the edge-bead removal subsystem at a first location proximate a first wafer surface during the first time, wherein the first location is determined using the first wafer position and/or the first thermal control position; e2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, the removed first residual liquid and/or gas comprising a first portion of the edge-bead material; e3) establishing a second wafer edge temperature during a third time, wherein the temperature control subsystem is moved to a second thermal control position proximate the wafer edge, the second thermal control position being determined using the first wafer position, the first thermal control position, or the first location, or a combination thereof; e4) positioning the edge-bead removal subsystem at a second location proximate the wafer edge during the third time, wherein the second location is determined using the first wafer position, the first thermal control position, the second thermal control position, or the first location, or a combination thereof; e5) providing a first rinsing agent to the first cleaning space using one or more of the first set of flow ports and removing at least one second residual liquid and/or gas using one or more of the second set of flow ports during a fourth time, wherein the wafer is rotated at a fourth speed during the fourth time, the removed second residual liquid and/or gas comprising a second portion of the edge-bead material; and e6) inspecting at least one wafer surface during a fifth time.

In a sixth example, the edge-bead removal procedure can include the following steps: f1) positioning the edge-bead removal subsystem at a first location proximate a first wafer surface during the first time, wherein the first location is determined using the first wafer position and/or the first thermal control position; f2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, the removed first residual liquid and/or gas comprising a first portion of the edge-bead material; f3) establishing a second wafer edge temperature during a third time, wherein the temperature control subsystem is moved to a second thermal control position proximate the wafer edge, the second thermal control position being determined using the first wafer position, the first thermal control position, or the first location, or a combination thereof; f4) positioning the edge-bead removal subsystem at a second location proximate the wafer edge during the third time, wherein the second location is determined using the first wafer position, the first thermal control position, the second thermal control position, or the first location, or a combination thereof; f5) providing a drying agent to the first cleaning space using one or more of the first set of flow ports and removing at least one second residual liquid and/or gas using one or more of the second set of flow ports during a fourth time, wherein the wafer is rotated at a fourth speed during the fourth time, the removed second residual liquid and/or gas comprising a second portion of the edge-bead material; and f6) inspecting at least one wafer surface during a fifth time.

In a seventh example, the edge-bead removal procedure can include the following steps: g1) positioning the edge-bead removal subsystem at a first location proximate a first wafer surface during the first time, wherein the first location is determined using the first wafer position and/or the first thermal control position; g2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, the removed first residual liquid and/or gas comprising a first portion of the edge-bead material, and the edge-bead removal subsystem is moved from the first location to a second location during the second time; g3) positioning the edge-bead removal subsystem at a third location proximate the wafer edge during a third time, wherein the third location is determined using the first wafer position, the first thermal control position, or the first location, the second location, or a combination thereof; g4) providing a second cleaning fluid to the first cleaning space using one or more of the first set of flow ports and removing at least one second residual liquid and/or gas using one or more of the second set of flow ports during a fourth time, wherein the wafer is rotated at a fourth speed during the fourth time, the removed second residual liquid and/or gas comprising a second portion of the edge-bead material; and g5) inspecting at least one wafer surface during a fifth time.

In a eighth example, the edge-bead removal procedure can include the following steps: h1) positioning the edge-bead removal subsystem at a first location proximate a first wafer surface during the first time, wherein the first location is determined using the first wafer position and/or the first thermal control position; h2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, the removed first residual liquid and/or gas comprising a first portion of the edge-bead material, and the edge-bead removal subsystem is moved from the first location to a second location during the second time; h3) positioning the edge-bead removal subsystem at a third location proximate the wafer edge during a third time, wherein the third location is determined using the first wafer position, the first thermal control position, or the first location, the second location, or a combination thereof; h4) providing a first rinsing agent to the first cleaning space using one or more of the first set of flow ports and removing at least one second residual liquid and/or gas using one or more of the second set of flow ports during a fourth time, wherein the wafer is rotated at a fourth speed during the fourth time, the removed second residual liquid and/or gas comprising a second portion of the edge-bead material; and h5) inspecting at least one wafer surface during a fifth time.

In a ninth example, the edge-bead removal procedure can include the following steps: i1) positioning the edge-bead removal subsystem at a first location proximate a first wafer surface during the first time, wherein the first location is determined using the first wafer position and/or the first thermal control position; i2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, the removed first residual liquid and/or gas comprising a first portion of the edge-bead material, and the edge-bead removal subsystem is moved from the first location to a second location during the second time; i3) positioning the edge-bead removal subsystem at a third location proximate the wafer edge during a third time, wherein the third location is determined using the first wafer position, the first thermal control position, or the first location, the second location, or a combination thereof; i4) providing a drying agent to the first cleaning space using one or more of the first set of flow ports and removing at least one second residual liquid and/or gas using one or more of the second set of flow ports during a fourth time, wherein the wafer is rotated at a fourth speed during the fourth time, the removed second residual liquid and/or gas comprising a second portion of the edge-bead material; and i5) inspecting at least one wafer surface during a fifth time.

In a tenth example, the edge-bead removal procedure can include the following steps: k1) positioning the edge-bead removal subsystem at a first location proximate a first wafer surface during the first time, wherein the first location is determined using the first wafer position and/or the first thermal control position; k2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, the removed first residual liquid and/or gas comprising a first portion of the edge-bead material and the edge-bead removal subsystem is moved from the first location to a second location during the second time; k3) establishing a second wafer edge temperature during a third time, wherein the temperature control subsystem is moved to a second thermal control position proximate the wafer edge, the second thermal control position being determined using the first wafer position, the first thermal control position, or the first location, or a combination thereof; k4) positioning the edge-bead removal subsystem at a third location proximate the wafer edge during the third time, wherein the third location is determined using the first wafer position, the first thermal control position, the second thermal control position, the first location, or the second location, or a combination thereof; k5) providing a second cleaning fluid to the first cleaning space using one or more of the first set of flow ports and removing at least one second residual liquid and/or gas using one or more of the second set of flow ports during a fourth time, wherein the wafer is rotated at a fourth speed during the fourth time, the removed second residual liquid and/or gas comprising a second portion of the edge-bead material; and k6) inspecting at least one wafer surface during a fifth time.

In an eleventh example, the edge-bead removal procedure can include the following steps: 11) positioning the edge-bead removal subsystem at a first location proximate a first wafer surface during the first time, wherein the first location is determined using the first wafer position and/or the first thermal control position; 12) providing a first cleaning fluid to the first cleaning space using at least one of the first set of flow ports and removing at least one first residual liquid and/or gas using at least one of the second set of flow ports during a second time, wherein the wafer is rotated at a second speed during the second time, the removed first residual liquid and/or gas comprising a first portion of the edge-bead material and the edge-bead removal subsystem is moved from the first location to a second location during the second time; 13) establishing a second wafer edge temperature during a third time, wherein the temperature control subsystem is moved to a second thermal control position proximate the wafer edge, the second thermal control position being determined using the first wafer position, the first thermal control position, or the first location, or a combination thereof; l4) positioning the edge-bead removal subsystem at a third location proximate the wafer edge during the third time, wherein the third location is determined using the first wafer position, the first thermal control position, the second thermal control position, the first location, or the second location, or a combination thereof; l5) providing a rinsing agent to the first cleaning space using one or more of the first set of flow ports and removing at least one second residual liquid and/or gas using one or more of the second set of flow ports during a fourth time, wherein the wafer is rotated at a fourth speed during the fourth time, the removed second residual liquid and/or gas comprising a second portion of the edge-bead material; and l6) inspecting at least one wafer surface during a fifth time.

In a twelfth example, the edge-bead removal procedure can include the following steps: m1) positioning the edge-bead removal subsystem at a first location proximate a first wafer surface during the first time, wherein the first location is determined using the first wafer position and/or the first thermal control position; m2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, the removed first residual liquid and/or gas comprising a first portion of the edge-bead material and the edge-bead removal subsystem is moved from the first location to a second location during the second time; m3) establishing a second wafer edge temperature during a third time, wherein the temperature control subsystem is moved to a second thermal control position proximate the wafer edge, the second thermal control position being determined using the first wafer position, the first thermal control position, or the first location, or a combination thereof; m4) positioning the edge-bead removal subsystem at a third location proximate the wafer edge during the third time, wherein the third location is determined using the first wafer position, the first thermal control position, the second thermal control position, the first location, or the second location, or a combination thereof; m5) providing a drying fluid to the first cleaning space using one or more of the first set of flow ports and removing at least one second residual liquid and/or gas using one or more of the second set of flow ports during a fourth time, wherein the wafer is rotated at a fourth speed during the fourth time, the removed second residual liquid and/or gas comprising a second portion of the edge-bead material; and m6) inspecting at least one wafer surface during a fifth time.

One or more of the controllers described herein may be coupled to a processing system controller (not shown) capable of providing data to the edge-bead removal system. The data can include wafer information, layer information, process information, and metrology information. Wafer information can include composition data, size data, thickness data, and temperature data. Layer information can include the number of layers, the composition of the layers, and the thickness of the layers. Process information can include data concerning previous steps and the current step. Metrology information can include optical digital profile data, such as critical dimension (CD) data, profile data, and uniformity data, and optical data, such as refractive index (n) data and extinction coefficient (k) data. For example, CD data and profile data can include information for features and open areas in one or more layers, and can include uniformity data. Each controller may comprise a microprocessor, a memory (e.g., volatile and/or non-volatile memory), and a digital I/O port. A program stored in the memory may be utilized to control the aforementioned components of a edge-bead removal system according to a process recipe. A controller may be configured to analyze the process data, to compare the process data with target process data, and to use the comparison to change a process and/or control the processing system components.

In some embodiments, one or more of the flow ports can be removably coupled to a flow controller to allow the flow ports to be removed, cleaned, and/or replaced during maintenance procedures. Flow controllers can be used to control the types of fluids and/or gasses provided to the flow ports, and the flow rates for the supplied fluids and/or gasses.

The system and methods of the invention can be used without damaging and/or altering the semiconductor materials, dielectric materials, low-k materials, and ultra-low-k materials.

In other embodiments, one or more of the flow ports can produce a spray pattern, and the spray pattern can be controlled and can be used during a self-cleaning procedure. For example, a fully automated self-cleaning process can be implemented to minimize human intervention and potential error. If customer defect levels require the edge-bead removal subsystem to be cleaned periodically, this can be programmed to occur. Down time and productivity lost due to Preventative Maintenance (PM) cleaning activities are minimized since the fully automated cleaning process/design allows the cleaning cycle to occur without stopping the entire tool. In addition, since the tools is not “opened” or disassembled, no post cleaning process testing (verification) is required. Furthermore, maintenance personnel are not exposed to solvent vapors, polymer residues or potential lifting or handling injuries since the components are not removed and/or cleaned by maintenance personnel. In other cases, one or more of the edge-bead removal subsystem components may be cleaned using external cleaning procedures. The self-cleaning frequency and the self-cleaning process can be programmable and can be executed based on time, number of wafers processed or exhaust values (alarm condition or minimum exhaust value measured during processing). Nitrogen or any other gas can also be used during a self-cleaning step.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative system and methods, and illustrative examples shown and described. Accordingly, departures may be made from such details without departing from the scope of applicants' general inventive concept.

What is claimed is:

1. A method of processing a wafer using a edge-bead removal system, the method comprising:
determining a first wafer position, wherein the wafer is rotated on a wafer holder in a processing chamber at a first speed during a first time, the wafer having a edge-bead material on one or more outer surfaces;
positioning a temperature control subsystem proximate a wafer edge, the temperature control subsystem establishing a first wafer edge temperature during the first time, wherein the temperature control subsystem is moved to a first thermal control position proximate the wafer edge, the first thermal control position being determined using the first wafer position;
positioning a edge-bead removal subsystem proximate a wafer surface, wherein the edge-bead removal subsystem is configured to provide a first set of fluids and/or gasses to a first cleaning space proximate the wafer edge using a first set of flow ports, and is configured to remove a second set of fluids and/or gasses from the first cleaning space using a second set of flow ports;
performing a edge-bead removal procedure using the edge-bead removal subsystem, wherein the edge-bead material is removed from the wafer;
determining a first processing state for the wafer, the first processing state being a first value when substantially all of the edge-bead material is removed and being a second value when the edge-bead material is partially removed;
removing the wafer from the processing chamber, if the first processing state is the first value; and
performing a corrective action, if the first processing state is the second value.

2. The method of claim 1, wherein performing the edge-bead removal procedure comprises:
positioning the edge-bead removal subsystem at a first location proximate a first wafer surface during the first time, wherein the first location is determined using the first wafer position, and/or the first thermal control position;
providing a first set of cleaning fluids and/or gasses to a first set of wafer surfaces proximate the wafer edge using at least one first directed flow through one or more of the first set of flow ports and at least one second directed flows through one or more of the second set of flow ports during a second time, wherein the wafer is rotated at a second speed during the second time and the edge-bead removal subsystem is moved from the first location to a second location during the second time; and
removing a first set of residual fluids and/or gasses from one or more surfaces of the wafer proximate the wafer edge using one or more additional directed flows during the second time, wherein the removed first set of residual fluids and/or gasses comprises a portion of the edge-bead material, the edge-bead removal subsystem being configured to provide one or more additional directed flows away from the one or more surfaces of the wafer using one or more of the first set of flow ports and/or one or more of the second set of flow ports.

3. The method of claim 1, wherein performing the edge-bead removal procedure comprises:
a1) positioning the edge-bead removal subsystem at a first location proximate a first wafer surface during the first time, wherein the first location is determined using the first wafer position and/or the first thermal control position;
a2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, a removed first residual liquid and/or gas comprising a first portion of the edge-bead material;
a3) positioning the edge-bead removal subsystem at a second location proximate the wafer edge during a third time, wherein the second location is determined using the first wafer position, the first thermal control position, or the first location, or a combination thereof;
a4) providing a second cleaning fluid to the first cleaning space using one or more of the first set of flow ports and removing at least one second residual liquid and/or gas using one or more of the second set of flow ports during a fourth time, wherein the wafer is rotated at a fourth speed during the fourth time, a removed second residual liquid and/or gas comprising a second portion of the edge-bead material; and
a5) inspecting at least one wafer surface during a fifth time.

4. The method of claim 1, wherein performing the edge-bead removal procedure comprises:
b1) positioning the edge-bead removal subsystem at a first location proximate a first wafer surface during the first time, wherein the first location is determined using the first wafer position and/or the first thermal control position;
b2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, a removed first residual liquid and/or gas comprising a first portion of the edge-bead material;
b3) positioning the edge-bead removal subsystem at a second location proximate the wafer edge during a third time, wherein the second location is determined using the first wafer position, the first thermal control position, or the first location, or a combination thereof;
b4) providing a first rinsing agent to the first cleaning space using one or more of the first set of flow ports and removing at least one second residual liquid and/or gas using one or more of the second set of flow ports during a fourth time, wherein the wafer is rotated at a fourth speed during the fourth time, a removed second residual liquid and/or gas comprising a second portion of the edge-bead material; and
b5) inspecting at least one wafer surface during a fifth time.

5. The method of claim 1, wherein performing the edge-bead removal procedure comprises:
c1) positioning the edge-bead removal subsystem at a first location proximate a first wafer surface during the first time, wherein the first location is determined using the first wafer position and/or the first thermal control position;
c2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, a removed first residual liquid and/or gas comprising a first portion of the edge-bead material;
c3) positioning the edge-bead removal subsystem at a second location proximate the wafer edge during a third time, wherein the second location is determined using the first wafer position, the first thermal control position, or the first location, or a combination thereof;
c4) providing a first drying agent to the first cleaning space using one or more of the first set of flow ports and removing at least one second residual liquid and/or gas using one or more of the second set of flow ports during a fourth time, wherein the wafer is rotated at a fourth speed during the fourth time, a removed second residual liquid and/or gas comprising a second portion of the edge-bead material; and
c5) inspecting at least one wafer surface during a fifth time.

6. The method of claim 1, wherein performing the edge-bead removal procedure comprises:
d1) positioning the edge-bead removal subsystem at a first location proximate a first wafer surface during the first time, wherein the first location is determined using the first wafer position and/or the first thermal control position;
d2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, a removed first residual liquid and/or gas comprising a first portion of the edge-bead material;
d3) establishing a second wafer edge temperature during a third time, wherein the temperature control subsystem is moved to a second thermal control position proximate the wafer edge, the second thermal control position being determined using the first wafer position, the first thermal control position, or the first location, or a combination thereof;
d4) positioning the edge-bead removal subsystem at a second location proximate the wafer edge during the third time, wherein the second location is determined using the first wafer position, the first thermal control position, the second thermal control position, or the first location, or any combination thereof;
d5) providing a second cleaning fluid to the first cleaning space using one or more of the first set of flow ports and removing at least one second residual liquid and/or gas using one or more of the second set of flow ports during a fourth time, wherein the wafer is rotated at a fourth speed during the fourth time, a removed second residual liquid and/or gas comprising a second portion of the edge-bead material; and
d6) inspecting at least one wafer surface during a fifth time.

7. The method of claim 1, wherein performing the edge-bead removal procedure comprises:
e1) positioning the edge-bead removal subsystem at a first location proximate a first wafer surface during the first time, wherein the first location is determined using the first wafer position and/or the first thermal control position;
e2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, a removed first residual liquid and/or gas comprising a first portion of the edge-bead material;
e3) establishing a second wafer edge temperature during a third time, wherein the temperature control subsystem is moved to a second thermal control position proximate the wafer edge, the second thermal control position being determined using the first wafer position, the first thermal control position, or the first location, or a combination thereof;
e4) positioning the edge-bead removal subsystem at a second location proximate the wafer edge during the third time, wherein the second location is determined using the first wafer position, the first thermal control position, the second thermal control position, or the first location, or any combination thereof;
e5) providing a first rinsing agent to the first cleaning space using one or more of the first set of flow ports and removing at least one second residual liquid and/or gas using one or more of the second set of flow ports during a fourth time, wherein the wafer is rotated at a fourth speed during the fourth time, a removed second residual liquid and/or gas comprising a second portion of the edge-bead material; and
e6) inspecting at least one wafer surface during a fifth time.

8. The method of claim 1, wherein performing the edge-bead removal procedure comprises:
f1) positioning the edge-bead removal subsystem at a first location proximate a first wafer surface during the first time, wherein the first location is determined using the first wafer position and/or the first thermal control position;
f2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, a removed first residual liquid and/or gas comprising a first portion of the edge-bead material;
f3) establishing a second wafer edge temperature during a third time, wherein the temperature control subsystem is moved to a second thermal control position proximate the wafer edge, the second thermal control position being determined using the first wafer position, the first thermal control position, or the first location, or a combination thereof;
f4) positioning the edge-bead removal subsystem at a second location proximate the wafer edge during the third time, wherein the second location is determined using the first wafer position, the first thermal control position, the second thermal control position, or the first location, or any combination thereof;
f5) providing a drying agent to the first cleaning space using one or more of the first set of flow ports and removing at least one second residual liquid and/or gas using one or more of the second set of flow ports during a fourth time, wherein the wafer is rotated at a fourth speed during the fourth time, a removed second residual liquid and/or gas comprising a second portion of the edge-bead material; and
f6) inspecting at least one wafer surface during a fifth time.

9. The method of claim 1, wherein performing the edge-bead removal procedure comprises:
g1) positioning the edge-bead removal subsystem at a first location proximate a first wafer surface during the first time, wherein the first location is determined using the first wafer position and/or the first thermal control position;
g2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, a removed first residual liquid and/or gas comprising a first portion of the edge-bead material, and the edge-bead removal subsystem is moved from the first location to a second location during the second time;
g3) positioning the edge-bead removal subsystem at a third location proximate the wafer edge during a third time, wherein the third location is determined using the first wafer position, the first thermal control position, or the first location, the second location, or a combination thereof;
g4) providing a second cleaning fluid to the first cleaning space using one or more of the first set of flow ports and removing at least one second residual liquid and/or gas using one or more of the second set of flow ports during a fourth time, wherein the wafer is rotated at a fourth speed during the fourth time, a removed second residual liquid and/or gas comprising a second portion of the edge-bead material; and
g5) inspecting at least one wafer surface during a fifth time.

10. The method of claim 1, wherein performing the edge-bead removal procedure comprises:
h1) positioning the edge-bead removal subsystem at a first location proximate a first wafer surface during the first time, wherein the first location is determined using the first wafer position and/or the first thermal control position;
h2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, a removed first residual liquid and/or gas comprising a first portion of the edge-bead material, and the edge-bead removal subsystem is moved from the first location to a second location during the second time;
h3) positioning the edge-bead removal subsystem at a third location proximate the wafer edge during a third time, wherein the third location is determined using the first wafer position, the first thermal control position, or the first location, the second location, or a combination thereof;
h4) providing a first rinsing agent to the first cleaning space using one or more of the first set of flow ports and removing at least one second residual liquid and/or gas using one or more of the second set of flow ports during a fourth time, wherein the wafer is rotated at a fourth speed during the fourth time, a removed second residual liquid and/or gas comprising a second portion of the edge-bead material; and
h5) inspecting at least one wafer surface during a fifth time.

11. The method of claim 1, wherein performing the edge-bead removal procedure comprises:
i1) positioning the edge-bead removal subsystem at a first location proximate a first wafer surface during the first time, wherein the first location is determined using the first wafer position and/or the first thermal control position;
i2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, a removed first residual liquid and/or gas comprising a first portion of the edge-bead material, and the edge-bead removal subsystem is moved from the first location to a second location during the second time;
i3) positioning the edge-bead removal subsystem at a third location proximate the wafer edge during a third time, wherein the third location is determined using the first wafer position, the first thermal control position, or the first location, the second location, or a combination thereof;
i4) providing a drying agent to the first cleaning space using one or more of the first set of flow ports and removing at least one second residual liquid and/or gas using one or more of the second set of flow ports during a fourth time, wherein the wafer is rotated at a fourth speed during the fourth time, a removed second residual liquid and/or gas comprising a second portion of the edge-bead material; and
i5) inspecting at least one wafer surface during a fifth time.

12. The method of claim 1, wherein performing the edge-bead removal procedure comprises:
k1) positioning the edge-bead removal subsystem at a first location proximate a first wafer surface during the first time, wherein the first location is determined using the first wafer position and/or the first thermal control position;
k2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, a removed first residual liquid and/or gas comprising a first portion of the edge-bead material and the edge-bead removal subsystem is moved from the first location to a second location during the second time;
k3) establishing a second wafer edge temperature during a third time, wherein the temperature control subsystem is moved to a second thermal control position proximate the wafer edge, the second thermal control position being determined using the first wafer position, the first thermal control position, or the first location, or a combination thereof;
k4) positioning the edge-bead removal subsystem at a third location proximate the wafer edge during the third time, wherein the third location is determined using the first wafer position, the first thermal control position, the second thermal control position, the first location, or the second location, or any combination thereof;
k5) providing a second cleaning fluid to the first cleaning space using one or more of the first set of flow ports and removing at least one second residual liquid and/or gas using one or more of the second set of flow ports during a fourth time, wherein the wafer is rotated at a fourth speed during the fourth time, a removed second residual liquid and/or gas comprising a second portion of the edge-bead material; and
k6) inspecting at least one wafer surface during a fifth time.

13. The method of claim 1, wherein performing the edge-bead removal procedure comprises:
l1) positioning the edge-bead removal subsystem at a first location proximate a first wafer surface during the first time, wherein the first location is determined using the first wafer position and/or the first thermal control position;
l2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, a removed first residual liquid and/or gas comprising a first portion of the edge-bead material and the edge-bead removal subsystem is moved from the first location to a second location during the second time;
l3) establishing a second wafer edge temperature during a third time, wherein the temperature control subsystem is moved to a second thermal control position proximate the wafer edge, the second thermal control position being determined using the first wafer position, the first thermal control position, or the first location, or a combination thereof;
l4) positioning the edge-bead removal subsystem at a third location proximate the wafer edge during the third time, wherein the third location is determined using the first wafer position, the first thermal control position, the second thermal control position, the first location, or the second location, or any combination thereof;
l5) providing a rinsing agent to the first cleaning space using one or more of the first set of flow ports and removing at least one second residual liquid and/or gas using one or more of the second set of flow ports during a fourth time, wherein the wafer is rotated at a fourth speed during the fourth time, a removed second residual liquid and/or gas comprising a second portion of the edge-bead material; and
l6) inspecting at least one wafer surface during a fifth time.

14. The method of claim 1, wherein performing the edge-bead removal procedure comprises:
m1) positioning the edge-bead removal subsystem at a first location proximate a first wafer surface during the first time, wherein the first location is determined using the first wafer position and/or the first thermal control position;
m2) providing a first cleaning fluid to the first cleaning space using at least one of the first set of flow ports and removing at least one first residual liquid and/or gas using at least one of the second set of flow ports during a second time, wherein the wafer is rotated at a second speed during the second time, a removed first residual liquid and/or gas comprising a first portion of the edge-bead material and the edge-bead removal subsystem is moved from the first location to a second location during the second time;
m3) establishing a second wafer edge temperature during a third time, wherein the temperature control subsystem is moved to a second thermal control position proximate the wafer edge, the second thermal control position being determined using the first wafer position, the first thermal control position, or the first location, or a combination thereof;
m4) positioning the edge-bead removal subsystem at a third location proximate the wafer edge during the third time, wherein the third location is determined using the first wafer position, the first thermal control position, the second thermal control position, the first location, or the second location, or any combination thereof;
m5) providing a drying agent to the first cleaning space using one or more of the first set of flow ports and removing at least one second residual liquid and/or gas using one or more of the second set of flow ports during a fourth time, wherein the wafer is rotated at a fourth speed during the fourth time, a removed second residual liquid and/or gas comprising a second portion of the edge-bead material; and
m6) inspecting at least one wafer surface during a fifth time.

15. A edge-bead removal system comprising:
a wafer holder in a processing chamber configured for rotating a wafer at a first speed during a first time, the wafer having a edge-bead material on one or more outer surfaces
one or more sensors configured for determining a first wafer position while the wafer is rotated on the wafer holder in the processing chamber at the first speed during the first time;
a temperature control subsystem configured for establishing a first wafer edge temperature during the first time, wherein the temperature control subsystem has a plurality of first coupling elements configured to move the temperature control subsystem to a first thermal control position proximate a wafer edge, the first thermal control position being determined using the first wafer position;
a edge-bead removal subsystem comprising a first set of flow ports configured to provide a first set of fluids and/or gasses to a first cleaning space proximate the wafer edge, and comprising a second set of flow ports configured to remove a second set of fluids and/or gasses from the first cleaning space, the edge-bead removal subsystem further comprising a plurality of second coupling elements configured to position the edge-bead removal subsystem proximate a wafer surface; and
a controller configured to perform a edge-bead removal procedure using the edge-bead removal subsystem, wherein the edge-bead material is removed from the wafer, configured for determining a first processing state for the wafer, the first processing state being a first value when substantially all of the edge-bead material is removed and being a second value when the edge-bead material is partially removed, configured to remove the wafer from the processing chamber, if the first processing state is the first value; and configured to perform a corrective action, if the first processing state is the second value.

16. A system for processing a wafer having edge-bead material on an outer surface, comprising:
a processing chamber having a wafer transfer port for transferring the wafer into and out of a process space;
a wafer table for positioning the wafer in the processing chamber when the wafer is processed;
a translation unit coupled to the processing chamber and the wafer table, the translation unit being configured to rotate the wafer table;
a temperature control subsystem coupled to the processing chamber, the temperature control subsystem being configured for establishing a first wafer edge temperature during a first time, wherein the temperature control subsystem has a plurality of first coupling elements configured to move the temperature control subsystem to a first thermal control position proximate a wafer edge, the first thermal control position being determined using a first wafer position;
a edge-bead removal subsystem coupled to the processing chamber, the edge-bead removal subsystem comprising a first set of flow ports configured to provide a first set of fluids and/or gasses to a first cleaning space proximate the wafer edge, and comprising a second set of flow ports configured to remove a second set of fluids and/or gasses from the first cleaning space, the edge-bead removal subsystem further comprising a plurality of second coupling elements configured to position the edge-bead removal subsystem proximate a wafer surface;
a supply subsystem coupled to the processing chamber, the supply subsystem being configured to provide processing fluids and/or gasses at correct temperatures and flow rates to the edge-bead removal subsystem; and
a controller configured to perform a edge-bead removal procedure using the edge-bead removal subsystem, wherein the edge-bead material is removed from the wafer, configured for determining a first processing state for the wafer, the first processing state being a first value when substantially all of the edge-bead material is removed and being a second value when the edge-bead material is partially removed, configured to remove the wafer from the processing chamber, if the first processing state is the first value; and configured to perform a corrective action, if the first processing state is the second value.

17. The system of claim 16, further comprising one or more exhaust ports configured to remove processing gasses from the process space.

18. The system of claim 16, further comprising one or more recovery systems configured to analyze, filter, re-use and/or remove one or more processing fluids.

19. The system of claim 16, further comprising one or more optical sensors for determining the first and/or second values.

20. The system of claim 16, further comprising an additional edge-bead removal subsystem coupled to the processing chamber, the additional edge-bead removal subsystem being configured to provide one or more additional fluids and/or gasses to the wafer.
